(19) United States
(12) Patent Application Publication
(10) Pub. No.: US 2026/0261871 A1
(43) Pub. Date: Sep. 3, 2026

(54) METHOD BY WHICH UE TRANSMITS MEASUREMENT REPORT RELATED TO SECOND CELL TO FIRST CELL, AND DEVICE THEREFOR

(71) Applicant: LG UPLUS CORP., Seoul (KR)

(72) Inventors: Jae Hyun AHN, Seoul (KR); Hyung Lok JUNG, Seoul (KR); Yong Hun PYUN, Seoul (KR); Jun Woo LEE, Seoul (KR); Chang Hun KIM, Seoul (KR); Byoung Jun LEE, Seoul (KR)

(21) Appl. No.: 18/846,601

(22) PCT Filed: Mar. 13, 2023
(86) PCT No.: PCT/KR2023/003374

§ 371 Date: Sep. 12, 2024

(30) Foreign Application Priority Data
Mar. 14, 2022 (KR) 10-2022-0031258
Apr. 19, 2022 (KR) 10-2022-0048405
Apr. 25, 2022 (KR) 10-2022-0050580
Apr. 25, 2022 (KR) 10-2022-0050581

(51) Int. Cl. H04W 24/02; H04W 36/00; H04W 36/32; H04W 84/06

(52) U.S. Cl. CPC H04W 24/02; H04W 36/00835; H04W 36/324; H04W 84/06

(57) ABSTRACT

One embodiment relates to a method by which a terminal transmits a measurement report in a wireless communication system, the method comprising: receiving a request for transmission of a first measurement report related to a second cell on a first cell; and, on the basis of the request for transmission, transmitting the first measurement report to the first cell, wherein the first measurement report includes aerial navigation information of the terminal.

### TECHNICAL FIELD

The present disclosure relates to a wireless communication system.

### BACKGROUND

Recently, new services enabled by urban aerial mobility (UAM) have been emerging. UAM refers to a service that provides transportation similar to taxis using vehicles that fly at altitudes of 300 to 600 meters above the ground, resulting in a wireless communication environment different from that on the ground.

For example, non-line of sight (NLOS) channel characteristics are predominant on the ground due to the presence of various objects, whereas line of sight (LOS) channel characteristics are more common in the air, which corresponds to an open space. Thus, for radio waves transmitted from the same base station, the cell coverage on the ground (i.e., the distance at which a radio wave is capable of being received to provide services) and the cell coverage in the air may differ from each other.

A handover is a crucial technology in mobile systems, which allows a user equipment (UE) to receive uninterrupted services by moving from one base station (BS) (e.g., source BS) to another BS (e.g., target BS) in the mobile systems. The handover involves communication between BSs and/or between the BS and the UE.

The handover begins as follows: a serving BS, which is currently providing services, initiates a handover preparation process between BSs based on measurement reports obtained from the UE and information on neighboring cells. In this case, the 3rd Generation Partnership Project (3GPP) standard suggests the use of an automatic neighbor relation (ANR) function as a method for acquiring information on neighboring cells.

The BS manages a table for neighboring BSs based on three attributes. The three attributes are No HO (handover is incapable of being performed), No Xn (there is no Xn interface), and No Remove (corresponding cell is incapable of being deleted). For example, if No HO is marked “X” and No Xn is marked “O,” it indicates that a direct handover (HO) via the Xn interface to the corresponding cell is not allowed. Therefore, the serving cell and UE may perform a HO using a next generation (NG) interface and an access and management function (AMF).

A new relay technology called integrated access and backhaul (IAB) is currently being discussed within 3GPP. The existing next generation node B (gNB), which is connected via wired infrastructure, is referred to as a donor gNB. Signals are relayed through IAB nodes, and final information is transmitted to the UE.

The IAB node appears as one UE to parent nodes (e.g., donor gNB) and is referred to as an integrated access and backhaul mobile termination (IAB-MT). The IAB node appears as a BS to child nodes (e.g., UE) and is referred to as an integrated access and backhaul distributed unit (IAB-DU).

Recently, 3GPP has been discussing a technology called a vehicle mobile relay (VMR), which involves providing services by placing a mobile IAB node on a vehicle. If a mobile IAB node is used in a vehicle, a UE onboard the vehicle may receive higher quality mobile communication services with lower power consumption, depending on the performance of the mobile IAB.

### DISCLOSURE

### Technical Problem

For radio waves transmitted from the same base station, the cell coverage on the ground and the cell coverage in the air may differ from each other. Thus, to support urban aerial mobility (UAM) services for a user equipment (UE), new functionalities are required for a wireless communication environment that differs from that on the ground.

### Technical Solution

In an aspect of the present disclosure, provided herein is a method of transmitting a measurement report by a user equipment (UE) in a wireless communication system. The method includes: receiving a transmission request for a first measurement report related to a second cell on a first cell; and transmitting the first measurement report on the first cell based on the transmission request. The first measurement report may include aerial operation information on the UE.

In another aspect of the present disclosure, provided herein is a UE configured to transmit a measurement report in a wireless communication system. The UE includes: at least one transceiver; at least one processor; and at least one memory operatively connected to the at least one processor and storing instructions that, when executed, cause the at least one processor to perform operations. The operations include: receiving a transmission request for a first measurement report related to a second cell on a first cell through the at least one transceiver; and transmitting the first measurement report on the first cell based on the transmission request through the at least one transceiver. The first measurement report may include aerial operation information on the UE.

In another aspect of the present disclosure, provided herein is a method of receiving a measurement report by a device in a wireless communication system. The method includes: transmitting a transmission request for a first measurement report related to a second cell to a UE on a first cell; and receiving the first measurement report from the UE on the first cell based on the transmission request. The first measurement report may include aerial operation information on the UE.

In another aspect of the present disclosure, provided herein is a device configured to receive a measurement report from a UE in a wireless communication system. The device includes: at least one transceiver; at least one processor; and at least one memory operatively connected to the at least one processor and storing instructions that, when executed, cause the at least one processor to perform operations. The operations include: transmitting a transmission request for a first measurement report related to a second cell to the UE on a first cell; and receiving the first measurement report from the UE on the first cell based on the transmission request. The first measurement report may include aerial operation information on the UE.

In this case, transmitting the first measurement report may include: receiving a global cell identification (ID) of the second cell on the second cell; and transmitting the first measurement report including the global cell ID of the second cell on the first cell.

In each aspect of the present disclosure, the global cell ID of the second cell may be received in a broadcasting message of the second cell.

In each aspect of the present disclosure, transmitting a second measurement report including signal strength information related to the second cell on the first cell may be further included.

In each aspect of the present disclosure, based on that information corresponding to the second cell is not present in a neighbor cell relation table (NCRT) of the first cell, the transmission request for the first measurement report may be received.

In each aspect of the present disclosure, the aerial operation information may include at least one of altitude information on an altitude at which the UE is located, signal strength measurement information on a signal strength of the second cell, or signal strength duration information on a duration of the signal strength.

In each aspect of the present disclosure, the altitude information may be absolute altitude information representing the altitude at which the UE is located as an absolute value.

In each aspect of the present disclosure, the altitude information may be altitude level information indicating an altitude level including the altitude at which the UE is located among a plurality of altitude levels.

In each aspect of the present disclosure, based on the aerial operation information, the altitude information may be mapped to the second cell within an NCRT of the first cell.

In each aspect of the present disclosure, based on that a value of the signal strength measurement information exceeds a first threshold, the altitude information may be mapped to the second cell within the NCRT.

In each aspect of the present disclosure, based on a value of the signal strength duration information exceeds a second threshold, the altitude information may be mapped to the second cell within the NCRT.

In each aspect of the present disclosure, based on the aerial operation information, a possibility of a handover to the second cell may be updated within an NCRT of the first cell.

In each aspect of the present disclosure, based on the aerial operation information, a necessity of an Xn interface for the second cell may be updated within an NCRT of the first cell.

In an aspect of the present disclosure, provided herein is a method of requesting formation of a slice for an urban aerial mobility (UAM) service by a UE in a wireless communication system. The method may include: performing authentication for a UAM service with a UAM UE included in a UAM device; generating slice information related to the UAM service based on the authentication; and transmitting a first message including the slice information to a base station.

In another aspect of the present disclosure, provided herein is a first UE configured to request formation of a slice for a UAM service in a wireless communication system. The first UE includes: a transceiver; and a processor connected to the transceiver. The processor may be configured to control the transceiver to perform authentication for a UAM service with a UAM UE included in a UAM device; generate slice information related to the UAM service based on the authentication; and transmit a first message including the slice information to a base station.

In another aspect of the present disclosure, provided herein is a method of supporting formation of a slice for a UAM service for a first UE by a UAM UE in a wireless communication system. The method may include: performing authentication for the UAM service with the first UE mounted on a UAM device related to the UAM UE; and transmitting a first message including authentication information on the first UE and slice information related to the UAM service to a base station.

In another aspect of the present disclosure, provided herein is a method of forming a slice for a UAM service with a first UE by a network in a wireless communication system. The method may include: configuring the slice for the UAM service; identifying the first UE related to the UAM service based on slice information related to the UAM service included in a first message; and forming the slice corresponding to the slice information with the first UE.

In another aspect of the present disclosure, provided herein is a network configured to form a slice for a UAM service with a first UE in a wireless communication system. The network includes a communication interface and a processor connected to the communication interface. The processor may be configured to: configure the slice for the UAM service; identify the first UE related to the UAM service based on slice information related to the UAM service included in a first message; and form the slice corresponding to the slice information with the first UE.

In each aspect of the present disclosure, the slice information may include single-network slice selection assistance information (S-NSSAI) on the UAM service.

In each aspect of the present disclosure, the S-NSSAI information may include slice service type (SST) and service differentiator (SD) values assigned to the UAM service.

In each aspect of the present disclosure, the authentication may be performed through transmission of at least one piece of authentication information including identification information on the first UE, operator information, and unique information on a user of the UE.

In each aspect of the present disclosure, the authentication may be performed through proximity communication, WiFi tethering, or sidelink communication with the UAM UE

In each aspect of the present disclosure, the first message may be transmitted to the base station when an altitude of the first UE exceeds a predetermined threshold altitude.

In each aspect of the present disclosure, the first message may be transmitted when a movement speed of the first UE exceeds a predetermined threshold speed.

In each aspect of the present disclosure, forming the slice with the base station based on the first message may be further included.

In each aspect of the present disclosure, the first UE may be reconfigured with a time-to-trigger (TTT) value and a tracking area (TA) through the formation of the slice.

In each aspect of the present disclosure, the first UE may be configured to perform wireless communication with the base station through a sidelink formed with the UAM UE when the slice is formed.

In each aspect of the present disclosure, the first message may be transmitted to the base station when an altitude of the UAM device exceeds a predetermined threshold altitude, and the first message may also be transmitted to the base station when a movement speed of the UAM device exceeds a predetermined threshold speed.

In each aspect of the present disclosure, the first message may be transmitted to the base station when the movement speed of the UAM device exceeds the predetermined threshold speed.

In an aspect of the present disclosure, provided herein is a method of supporting a UAM service for a UE by a first server in a wireless communication system. The method may include: receiving authentication information on a first UE related to the UAM service from a UAM device; and transmitting a request message to a network exposure function (NEF) based on the authentication information. The request message may be a message defined to request an update of service information per UE.

In another aspect of the present disclosure, provided herein is a first server configured to support a UAM service for a UE in a wireless communication system. The first server may include a communication interface and a processor connected to the communication interface. The processor may be configured to control the communication interface to receive authentication information on a first UE related to the UAM service from a UAM device; and transmit a request message to an NEF based on the authentication information. The request message may be a message defined to request an update of service information per UE.

In another aspect of the present disclosure, provided herein is a method of identifying a first UE related to a UAM service by a network in a wireless communication system. The method may include: receiving from a first server a first message requesting an update of service information; and identifying the first UE related to the UAM service based on UAM service information corresponding to the first message. The first message may be a message defined to request an update of service information per UE.

In an aspect of the present disclosure, provided herein is a network configured to identify a first UE related to a UAM service in a wireless communication system. The network may include a communication interface and a processor connected to the communication interface. The processor may be configured to control the communication interface to receive from a first server a first message requesting an update of service information for the first UE;

and identify the first UE related to the UAM service based on UAM service information corresponding to the first message. The first message may be a message defined to request an update of service information per UE.

In each aspect of the present disclosure, the authentication information may be received when the UE is mounted on the UAM device.

In each aspect of the present disclosure, the authentication information may include at least one of identification information on the UE, operator information, and unique information on a user of the UE.

In each aspect of the present disclosure, identifying the NEF related to the UE based on the authentication information may be further included.

In each aspect of the present disclosure, the request message may include identification information on the UE and indication information indicating that the UE is mounted on a device related to the UAM service.

In each aspect of the present disclosure, a response message may be received from the NEF. The response message may be defined as a message for indicating that the update of the service information per UE corresponding to the authentication information is completed in a unified data repository (UDR) included in the network.

In each aspect of the present disclosure, the request message may be a message of the type nef_UEParameter_Update_Request.

In each aspect of the present disclosure, the first server may be an unmanned aerial system traffic management (UTM) server.

In each aspect of the present disclosure, the UAM service information may include a quality class identifier (QCI) assigned for the UAM service.

In each aspect of the present disclosure, the UAM service information may include a service profile identifier SPID or a slice ID (S-NSSAI) assigned for the UAM service.

In each aspect of the present disclosure, the UAM service information may further include identification information on the first UE.

In each aspect of the present disclosure, the UAM service information may be included in a message of the type Namf_Communication_N1N2MessageTransfer that is transmitted from a policy control function (PCF) to an access and mobility management function (AMF) in the network.

In each aspect of the present disclosure, establishing a policy for the UAM service for the first UE based on the first message may be further included.

In each aspect of the present disclosure, the establishment of the policy may be performed by the PCF included in the network, which receives a message of the type Nudr_DM_notify including the service information updated for the first UE.

In each aspect of the present disclosure, the first message may be a message of the type nef_UEParameter_Update_Request that requests the NEF included in the network to update the service information.

In each aspect of the present disclosure, the network may transmit a third message to the first server when the update of the service information for the first UE is completed.

In each aspect of the present disclosure, the third message may be a message of the type Nnef_UEParameter_Update_Response transmitted by the NEF included in the network.

In each aspect of the present disclosure, the first message may include identification information on the first UE and indication information indicating that the first UE is mounted on the UAM device providing the UAM service.

In each aspect of the present disclosure, the network may transmit a message to the base station (BS) that includes the QCI, the SPID, or the slice ID (S-NSSAI) assigned for the UAM service to reconfigure parameters for the first UE.

In an aspect of the present disclosure, provided herein is a method of transmitting radio resource control (RRC) configuration information to a UE by an integrated access and backhaul (IAB) node in a wireless communication system. The method may include: transmitting information on the UE connected to the IAB node to a BS; reporting measurement information related to a height of the IAB node to the BS; receiving the RRC configuration information for the UE from the BS based on the measurement information; and transmitting the RRC configuration information to the UE.

In another aspect of the present disclosure, provided herein is an IAB node configured to transmit RRC configuration information to a UE in a wireless communication system. The IAB node includes: at least one transceiver; at least one processor; and at least one memory operatively connected to the at least one processor and storing instructions that, when executed, cause the at least one processor to perform operations. The operations may include: transmitting information on the UE connected to the IAB node to a BS through the at least one transceiver; reporting measurement information related to a height of the IAB node to the BS through the at least one transceiver; receiving the RRC configuration information for the UE from the BS based on the measurement information through the at least one transceiver; and transmitting the RRC configuration information to the UE through the at least one transceiver.

In another aspect of the present disclosure, provided herein is a method of transmitting RRC configuration information for a UE to an IAB node by a BS in a wireless communication system. The method may include: receiving information on the UE connected to the IAB node from the IAB node; receiving measurement information related to a height of the IAB node from the IAB node; and transmitting the RRC configuration information for the UE to the IAB node based on the measurement information.

In another aspect of the present disclosure, provided herein is a BS configured to transmit RRC configuration information for a UE to an IAB node in a wireless communication system. The BS includes: at least one transceiver; at least one processor; and at least one memory operatively connected to the at least one processor and storing instructions that, when executed, cause the at least one processor to perform operations. The operations may include: receiving information on the UE connected to the IAB node from the IAB node through the at least one transceiver; receiving measurement information related to a height of the IAB node from the IAB node through the at least one transceiver; and transmitting the RRC configuration information for the UE to the IAB node based on the measurement information through the at least one transceiver.

In each aspect of the present disclosure, transmitting to the BS an indicator indicating that the IAB node is a mobile IAB node may be further included.

In each aspect of the present disclosure, reporting the measurement information may include receiving information on a plurality of thresholds related to heights from the BS and reporting to the BS a threshold corresponding to a height of the IAB node among the plurality of thresholds.

In each aspect of the present disclosure, reporting the measurement information may include reporting to the BS at least one of an absolute altitude value related to the height of the IAB node and a measurement strength measured by the IAB node.

In each aspect of the present disclosure, the measurement strength may be at least one of a reference signal received power (RSRP), a reference signal received quality (RSRQ), a received signal strength indicator (RSSI), or a signal to interference & noise ratio (SINR)

In each aspect of the present disclosure, the RRC configuration information may include cell reselection information.

In each aspect of the present disclosure, the cell reselection information may include at least one of a physical ID of an IAB-DU (distributed unit) included in the IAB and cell reselection fail time information.

In each aspect of the present disclosure, the RRC configuration information may include TTT information, which is a minimum duration required for reporting the measurement information.

In each aspect of the present disclosure, the TTT information may be configured differently for each of the plurality of thresholds related to the heights for the measurement information.

In each aspect of the present disclosure, receiving from the UE a response regarding the RRC configuration information may be further included.

In each aspect of the present disclosure, the measurement report may be reported only if the height of the IAB node exceeds a specific threshold.

In each aspect of the present disclosure, determining one or more UEs supposed to receive the RRC configuration information among a plurality of UEs connected to the IAB node may be further included. The RRC configuration information may be generated for each of the one or more UEs.

### Advantageous Effects

According to some implementations of the present disclosure, when automatic neighbor relation (ANR) functionality is used in a network providing urban aerial mobility (UAM) services, if an indicator to distinguish between terrestrial and non-terrestrial user equipments (UEs) is added, it may prevent confusion in the formation of an ANR table. The confusion may arise from the inability to clearly distinguish between the terrestrial and non-terrestrial UEs, which may lead to different neighbor cell detection reports for the same neighboring cell.

According to some implementations of the present disclosure, a final ANR table may have separate tables for terrestrial networks and non-terrestrial networks, and the terrestrial network table may be maintained as it is by excluding detection reports from non-terrestrial UEs.

According to some implementations of the present disclosure, a first UE may transmit slice information related to a UAM service during a process of being mounted on and authenticated by a UAM device, thereby enabling a network to efficiently identify the first UE as a UE related to the UAM service.

According to some implementations of the present disclosure, the network may selectively establish and provide a communication environment suitable for the UAM service for UEs using the UAM service based on the identification of the first UE related to the UAM service.

According to some implementations of the present disclosure, an unmanned aerial system traffic management (UTM) server may transmit a newly defined message for updating services per UE to the network, thereby allowing the network to effectively identify a mounted UE, which is a UE receiving the UAM service.

According to some implementations of the present disclosure, the network may selectively establish and provide a communication environment suitable for the UAM service for the mounted UE based on the identification of the mounted UE.

According to some implementations of the present disclosure, in a future network providing UAM services, a flying taxi may be equipped with a mobile integrated access and backhaul (IAB) node to achieve mobile communication services. If a process of integrating information about UEs that are not adequately provided with UAM services with information on the mobile IAB-node of the flying taxi is added, UEs receiving UAM services from the flying taxi may receive configuration information which differs from existing RRC configuration information provided by terrestrial base stations.

According to some implementations of the present disclosure, in a wireless communication environment different from that on the ground, frequent handovers of UEs may be prevented, and UAM services may be supported with low power consumption.

According to some implementations of the present disclosure, in a wireless communication environment different from that on the ground, it is possible to prevent measurement information collected from UEs from interfering with the existing terrestrial network automation (self-organizing network (SON)).

The effects obtainable from the present disclosure are not limited to what has been described above, and other effects not explicitly described may become apparent to those skilled in the art from the detailed description below.

### BRIEF DESCRIPTION OF THE DRAWINGS

FIG. 1 is a diagram for explaining urban aerial mobility (UAM) services according to an embodiment of the present disclosure.

FIG. 2 illustrates the structure of a New Radio (NR) system according to an embodiment of the present disclosure.

FIG. 3 illustrates functional split between a next generation radio access network (NG-RAN) and a fifth generation core (5GC) according to an embodiment of the present disclosure.

FIG. 4 is a diagram for explaining a conventional automatic neighbor relation (ANR) function.

FIGS. 5 and 6 are diagrams for explaining a conventional neighbor cell detection process.

FIG. 7 is a diagram for explaining a neighbor cell detection process according to an embodiment of the present disclosure.

FIGS. 8 and 9 are diagrams for explaining a method of performing ANR updates according to an embodiment of the present disclosure.

FIGS. 10 to 12 are diagrams for explaining various devices to which embodiments of the present disclosure are applicable.

FIG. 13 is a block diagram for specifically explaining a 5G NR system.

FIG. 14 is a diagram for explaining network slicing.

FIG. 15 is a diagram for explaining a method by which a first user equipment (UE) mounted in a UAM device performs an authentication procedure with a UAM UE.

FIG. 16 is a diagram for explaining a method by which a first UE, a base station (BS), and a network form a slice related to a UAM service.

FIG. 17 is a flowchart for explaining a method by which a first UE requests a BS or network to form a slice related to a UAM service.

FIG. 18 is a diagram for explaining a method by which a network identifies a first UE receiving a UAM service and forms a slice for the UAM service.

FIG. 19 is a diagram for explaining a method by which a network receives a first message and identifies a UE related to a UAM service.

FIG. 20 is a diagram for explaining a method by which an unmanned aerial system traffic management (UTM) server provides information on a UE receiving a UAM service to a network.

FIG. 21 is a diagram for explaining a method by which a UTM server, a network, and a UAM UE support UAM services.

FIG. 22 is a flowchart for explaining a method by which a UTM server transmits a request message for identifying a UE related to a UAM service to a network.

FIG. 23 is a flowchart for explaining a method by which a network receives a first message and identifies a UE related to a UAM service.

FIG. 24 is a block diagram for explaining a server supporting UAM services.

FIG. 25 is a diagram schematically illustrating an example of an integrated access and backhaul link.

FIG. 26 is a schematic diagram illustrating an example of links between a donor next generation node B (DgNB), a relay node (RN), and a UE.

FIG. 27 is a diagram for explaining Stand-Alone (SA) and Non-Stand-Alone (NSA) operations of an IAB node.

FIG. 28 schematically illustrates an example of backhaul and access links.

FIG. 29 schematically illustrates an example of parent and child links.

FIG. 30 schematically illustrates a configuration between nodes.

FIG. 31 schematically illustrates an example where a mobile termination (MT) and a parent distributed unit (DU) of an integrated access and backhaul (IAB) node are configured with a plurality of component carriers (CCs).

FIG. 32 illustrates an implementation example of an IAB node according to an embodiment of the present disclosure.

FIG. 33 illustrates an initial access procedure for a UE.

FIG. 34 illustrates an initial access procedure for a UE through an IAB node.

FIG. 35 illustrates an initial access procedure for a UE through an IAB node according to an embodiment of the present disclosure.

### DETAILED DESCRIPTION

The terms or words used in the following description and drawings should not be interpreted as being limited to the usual or dictionary meanings thereof. The terms or words need to be interpreted in accordance with the meaning and concept that align with the technical spirit of the present disclosure based on the principle that the inventor may appropriately define the terms or words to best describe the disclosure. The embodiments described in the present disclosure and the configurations shown in the drawings are merely the most preferred examples of the present disclosure and do not represent the entirety of the technical spirit of the present disclosure. Thus, it should be understood that there may be various equivalents and modifications that may substitute the embodiments and configurations at the time of this application.

The terms including ordinal numbers, such as first and second, are used merely for the purpose of distinguishing between different components and are not intended to limit the components. For example, without departing from the scope of the present disclosure, a second component may be referred to as a first component, and similarly, a first component may be referred to as a second component.

The terms used in the present disclosure are employed solely to describe specific embodiments and are not intended to limit the present disclosure. Singular expressions include plural expressions unless the context clearly indicates otherwise. In addition, terms such as “comprises” or “has” as used in the present disclosure are intended to specify the presence of features, numbers, steps, operations, components, parts, or combinations thereof described in the specification but do not preclude the presence or addition of one or more other features, numbers, steps, operations, components, parts, or combinations thereof.

The terms such as “unit,” “device,” or “module” used in the specification refer to a unit that processes at least one function or operation, which may be implemented in hardware, software, or a combination of hardware and software. The terms such as “a,” “an,” “one,” “the,” and similar related words may be used to refer to both the singular and plural forms, unless otherwise specified or clearly contradicted by the context in which the present disclosure is described (particularly in the context of the following claims).

In addition to the terms mentioned above, specific terms used in the following description are provided to aid in the understanding of the present disclosure. The use of these specific terms may be modified in other forms without departing from the technical spirit of the present disclosure.

The embodiments within the scope of the present disclosure include computer-readable media that include or transmit computer-executable instructions or data structures stored on a computer-readable medium. Such computer-readable media may be any available medium accessible by a general-purpose or special-purpose computer system. For example, such computer-readable media may include, but are not limited to, random access memory (RAM), read-only memory (ROM), erasable programmable read-only memory (EPROM), compact disc read-only memory (CD-ROM), optical disk storage, magnetic disk storage, magnetic storage devices, or any other physical storage media that are capable of being used to store or transmit desired program code means in the form of computer-executable instructions, computer-readable instructions, or data structures and accessed by a general-purpose or special-purpose computer system.

The present disclosure may be implemented in a network computing environment with various types of computer system configurations including personal computers (PCs), laptop computers, handheld devices, multiprocessor systems, microprocessor-based or programmable consumer electronics, network PCs, minicomputers, mainframe computers, mobile phones, personal digital assistants (PDAs), pagers, and so on. The present disclosure may also be implemented in a distributed system environment where tasks are performed by both local and remote computer systems linked through a network via wired data links, wireless data links, or a combination of wired and wireless data links. In the distributed system environment, program modules may be located in both local and remote memory storage devices.

It will be understood that each block of the flowchart and/or block diagram and combinations of blocks in the flowchart and/or block diagram may be implemented by computer program instructions. Since the computer program instructions may be loaded onto a general-purpose computer, a special-purpose computer, or a processor for other programmable data processing devices, the instructions executed by the computer or processor for other programmable data processing devices may create means for performing the functions described in the flowchart block(s). The computer program instructions may also be stored in a computer-usable or computer-readable memory that may direct a computer or other programmable data processing devices to function in a particular manner, such that the instructions stored in the computer-usable or computer-readable memory produce an article of manufacture including instructions that implement the functions described in the flowchart block(s). The computer program instructions may also be loaded onto a computer or other programmable data processing devices to cause a series of operational steps to be performed on the computer or other programmable data processing devices to produce a computer-implemented process, where the instructions executed by the computer or other programmable data processing devices provide steps for performing the functions described in the flowchart block(s).

Each block may represent a module, segment, or portion of code that includes one or more executable instructions for performing the specified logical function(s). It should also be noted that, in some alternative implementations, the functions noted in the blocks may occur out of the order noted therein. For example, two blocks shown in succession may be executed substantially concurrently, or the blocks may sometimes be executed in the reverse order, depending upon the functionality.

In specifically describing the embodiments of the present disclosure, examples of a particular system will primarily be the focus. However, the main point claimed in the present disclosure may be applied to other communication systems and services with a similar technical background without significantly departing from the scope of the present disclosure. This would be achievable based on the judgment of those skilled in the relevant technical field.

In various embodiments of the present disclosure, “/” and “,” should be interpreted as indicating “and/or.” For example, “A/B” may mean “A and/or B.” In addition, “A, B” may mean “A and/or B.” Additionally, “A/B/C” may mean “at least one of A, B, and/or C.” Similarly, “A, B, C” may mean “at least one of A, B, and/or C.”

In various embodiments of the present disclosure, “or” should be interpreted as indicating “and/or.” For example, “A or B” may include “only A,” “only B,” and/or “both A and B.” In other words, “or” should be interpreted as meaning “additionally or alternatively.”

The following description may be applied to various wireless communication systems, such as code division multiple access (CDMA), frequency division multiple access (FDMA), time division multiple access (TDMA), orthogonal frequency division multiple access (OFDMA), and single carrier frequency division multiple access (SC-FDMA). CDMA may be implemented using wireless technologies such as universal terrestrial radio access (UTRA) or CDMA2000. TDMA may be implemented using wireless technologies such as global system for mobile communications (GSM), general packet radio service (GPRS), or enhanced data rates for GSM evolution (EDGE). OFDMA may be implemented using wireless technologies such as Institute of Electrical and Electronics Engineers (IEEE) 802.11 (Wi-Fi), IEEE 802.16 (WiMAX), IEEE 802.20, or evolved UTRA (E-UTRA). IEEE 802.16m is an evolution of IEEE 802.16e and provides backward compatibility with systems based on IEEE 802.16e. UTRA is part of universal mobile telecommunications system (UMTS). 3GPP Long Term Evolution (LTE) is part of evolved UMTS (E-UMTS), which uses evolved-UMTS terrestrial radio access (E-UTRA). LTE employs OFDMA in downlink and SC-FDMA in uplink. Long Term Evolution Advanced (LTE-A)) is an evolution of 3GPP LTE.

Fifth Generation New Radio (5G NR) is a successor technology to LTE-A, representing a new clean-slate mobile communication system characterized by high performance, low latency, and high availability. 5G NR may use all available spectrum resources, ranging from low-frequency bands below 1 GHZ, mid-frequency bands between 1 GHz and 10 GHz, to high-frequency (millimeter-wave) bands above 24 GHz.

For the sake of clarity, the description primarily focuses on LTE-A or 5G NR, but the technical spirit of the present disclosure is not limited thereto.

Hereinafter, 5G, a representative communication field to which the present disclosure is applicable, will be described. The three main requirement areas of 5G include: (1) Enhanced Mobile Broadband (eMBB), (2) massive Machine Type Communication (mMTC), and (3) Ultra-Reliable and Low Latency Communications (URLLC).

Some use cases may require multiple areas to be optimized, while other use cases may focus on just one key performance indicator (KPI). 5G is designed to support these diverse use cases in a flexible and reliable manner.

First, eMBB goes far beyond basic mobile internet access and covers rich interactive operations, media, and entertainment applications in the cloud or augmented reality. Data is one of the key drivers of 5G, and for the first time in the 5G era, and dedicated voice services may not be provided for the first time in the 5G era. In 5G, voice is expected to be handled as an application program, simply using data connectivity provided by a communication system. The main causes for the increased traffic volume are the growth in content size and the rising number of applications requiring high data transfer rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing on mobile communication platforms, which may be applied to both work and entertainment. Cloud storage, in particular, is a use case that drives the growth of uplink data transfer rates. 5G is also used for remote work in the cloud and requires much lower end-to-end latency to maintain an excellent user experience, especially when haptic interfaces are used. Entertainment will be very essential on smart phones and tablets everywhere, including high mobility environments such as trains, cars and airplanes. Another use case is augmented reality for entertainment and information search, which requires very low latencies and significant instant data volumes. In entertainment, cloud gaming and video streaming are additional key factors driving the demand for mobile broadband capabilities. Entertainment on smartphones and tablets is essential in any environment, including high-mobility settings such as trains, vehicles, and airplanes. Another use case is augmented reality and information retrieval for entertainment. In this case, augmented reality requires very low latency and instantaneous data volumes.

One of the most anticipated 5G use cases is mMTC, the functionality of actively connecting embedded sensors in all fields. It is expected that there will be 20.4 billion potential Internet of things (IoT) devices by 2020. Industrial IoT is one of the areas where 5G will play a key role in enabling smart cities, asset tracking, smart utilities, agriculture, and security infrastructure.

URLLC includes new services that will transform industries through ultra-reliable, low-latency links, such as the remote control of critical infrastructure and self-driving vehicles. The levels of reliability and latency are essential for smart grid control, industrial automation, robotics, drone control, and coordination.

5G may complement fiber-to-the-home (FTTH) and cable-based broadband (or data-over-cable service interface specifications (DOCSIS)) as a means of providing streams at data rates of hundreds of megabits per second to gigabits per second. Such high speeds are required for delivering virtual reality and augmented reality, as well as for streaming TV in resolutions beyond 4K (6K, 8K, and higher). Virtual reality (VR) and augmented reality (AR) applications include highly immersive sports events. Specific applications may require special network configurations. For example, in the case of VR gaming, game companies may need to integrate core servers with edge network servers of network operators to minimize latency.

The automotive sector is expected to be a significant new driver for 5G, with many use cases related to mobile communication for vehicles. For example, entertainment for passengers requires simultaneous high capacity and high mobility mobile broadband. This is because future users will continue to expect high-quality connectivity regardless of their location and speed. Another use case in the automotive sector is the AR dashboard. The AR dashboard displays information overlaid on what a driver sees through the front windshield, helping to identify objects in the dark and providing details about the distance and movement of the objects. In the future, wireless modules will enable communication between vehicles, between vehicles and supporting infrastructure, and between vehicles and other connected devices (e.g., devices carried by pedestrians). Safety systems will guide alternative courses of action to help the driver drive more safely, thereby reducing the risk of accidents. The next step will be remote-controlled or self-driving vehicles. To this end, highly reliable and ultra-fast communication may be required between different self-driving vehicles and between vehicles and infrastructure. In the future, self-driving vehicles will handle all driving activities, while the driver may only focus on traffic anomalies that vehicles are incapable of detecting. The technical requirements for self-driving vehicles will demand ultra-low latency and ultra-reliable high-speed communication to improve traffic safety to levels unattainable by human drivers.

Smart cities and smart homes, often referred to as part of a smart society, will be embedded with high-density wireless sensor networks. Distributed networks of intelligent sensors will identify conditions for cost- and energy-efficient maintenance of the city or home. Similar setups may be implemented for individual households, where temperature sensors, window and heating controllers, burglar alarms, and home appliances are all connected wirelessly. Many of these sensors typically have low data transfer rates, low power consumption, and low cost. However, real time high definition (HD) video may be required in some types of devices for surveillance.

The consumption and distribution of energy, including heat or gas, are becoming highly decentralized, requiring automated control through distributed sensor networks. A smart grid interconnects such sensors using digital information and communication technologies to collect information and act based on the information. Since the information may include the behavior of both suppliers and consumers, the smart grid may improve the efficiency, reliability, economy, sustainability of production, and automated distribution of fuels such as electricity. The smart grid may also be seen as another low-latency sensor network.

Mission-critical applications (e.g., e-health) are one of the 5G use scenarios. The healthcare sector has many applications that may benefit from mobile communication. Communication systems may support telemedicine, which provides clinical care from a distance. Telemedicine may help reduce barriers related to distance and improves access to healthcare services that are not consistently available in remote rural areas and also be used to save lives in critical care and emergency situations. Mobile communication-based wireless sensor networks may provide remote monitoring and sensors for parameters such as heart rate and blood pressure.

Wireless and mobile communications are becoming increasingly important in industrial applications. Wiring has high installation and maintenance costs. Therefore, the possibility of replacing cables with reconfigurable wireless links presents an attractive opportunity in many industrial sectors. However, to this end, it is required that the wireless connection operates with similar latency, reliability, and capacity as cables and that the management thereof is also simplified. Low latency and very low error rates are new requirements that need to be addressed for 5G connectivity.

Logistics and freight tracking are important use cases for mobile communication that enable inventory and package tracking from anywhere using location-based information systems. The logistics and freight tracking use cases typically require lower data rates but need wide coverage and reliable location information.

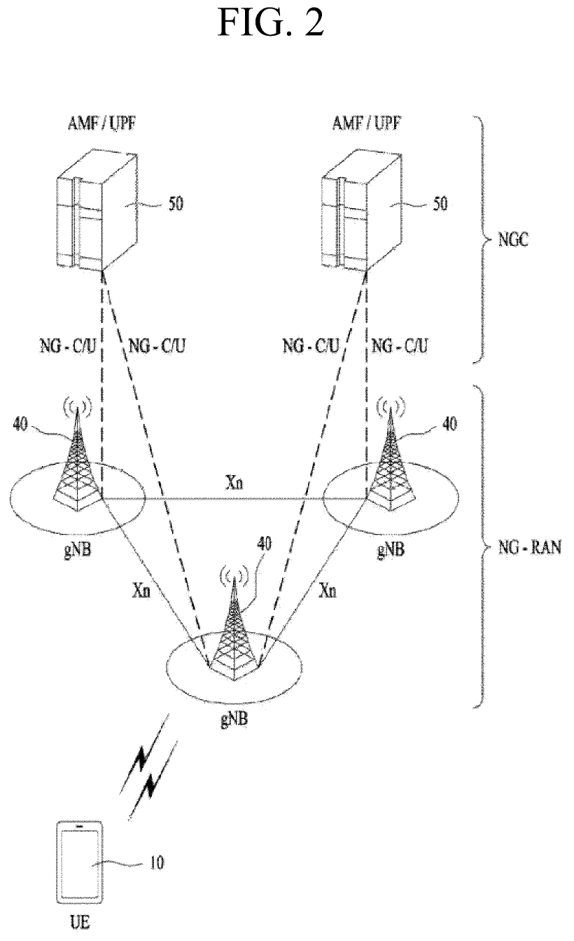

FIG. 2 is a diagram for explaining an embodiment of a network architecture in a 5G NR system.

The network of the NR system is primarily composed of a next generation radio access network (NG-RAN) and a next generation core (NGC) network. An NGC is also referred to as a fifth generation core (5GC).

Referring to FIG. 2, the NG-RAN includes next generation nodes B (gNBs) gNBs that provide the termination of user plane protocols (e.g., service data adaptation protocol (SDAP), packet data convergence protocol (PDCP), radio link control (RLC), medium access control (MAC), and physical (PHY)) and control plane protocols (e.g., radio resource control (RRC), PDCP, RLC, MAC, and PHY) for a user equipment (UE). The gNBs are interconnected through an Xn interface. The gNBs are connected to the NGC through an NG interface. For example, the gNB is connected to a core network node having an access and mobility management function (AMF) through an N2 interface, which is one of the interfaces between the gNB and the NGC. Additionally, the gNB is connected to another core network node with a user plane function (UPF) through an N3 interface, which is another interface between the gNB and the NGC. The AMF and UPF may be implemented by different core network devices or by a single core network device. In the RAN, the transmission and reception of signals between a base station (BS) and a UE are performed through a radio interface. For example, in the RAN, the transmission and reception of signals between the BS and UE are carried out through physical resources (e.g., radio frequency (RF)). In contrast, in the core network, the transmission and reception of signals between the gNB and network functions (e.g., AMF, UPF, etc.) are performed not via a radio interface but through physical connections (e.g., optical cables) between core network nodes or through logical connections between core network functions.

The radio protocol stack in the 3GPP system is broadly divided into two types: a protocol stack for the user plane and a protocol stack for the control plane. The user plane, also known as a data plane, is used to carry user traffic (i.e., user data). The user plane handles user data such as voice and data. In contrast, the control plane deals with control signaling, which is not user data, between UEs or between UEs and network nodes. In the LTE system, the protocol stack for the user plane includes PDCP, RLC, MAC, and PHY. In the NR system, the protocol stack for the user plane includes SDAP, PDCP, RLC, MAC, and PHY. In the LTE and NR systems, the protocol stack for the control plane includes PDCP, RLC, and MAC, which terminate at the BS on the network side. Additionally, the protocol stack for the control plane includes an RRC layer, which is a higher layer of PDCP, and a non-access stratum (NAS) control protocol, which is a higher layer of RRC. The NAS protocol terminates at the AMF in the core network on the network side and handles mobility management and bearer management. RRC supports the transfer of NAS signaling and performs functions required for efficient management of radio resources. For example, RRC supports the following functions: broadcasting of system information; establishment, maintenance, and release of RRC connections between the UE and the BS; establishment, configuration, maintenance, and release of radio bearers; UE measurement reporting and control of reporting; detection and recovery of radio link failures; and transfer of NAS messages to and from the UE.

In the present disclosure, RRC messages/signaling by or from the BS refers to RRC messages/signaling transmitted by the RRC layer of the BS to the RRC layer of the UE. The UE is configured or operates based on parameter(s) or a set of parameters, known as information elements (IEs), included in the RRC messages/signaling from the BS.

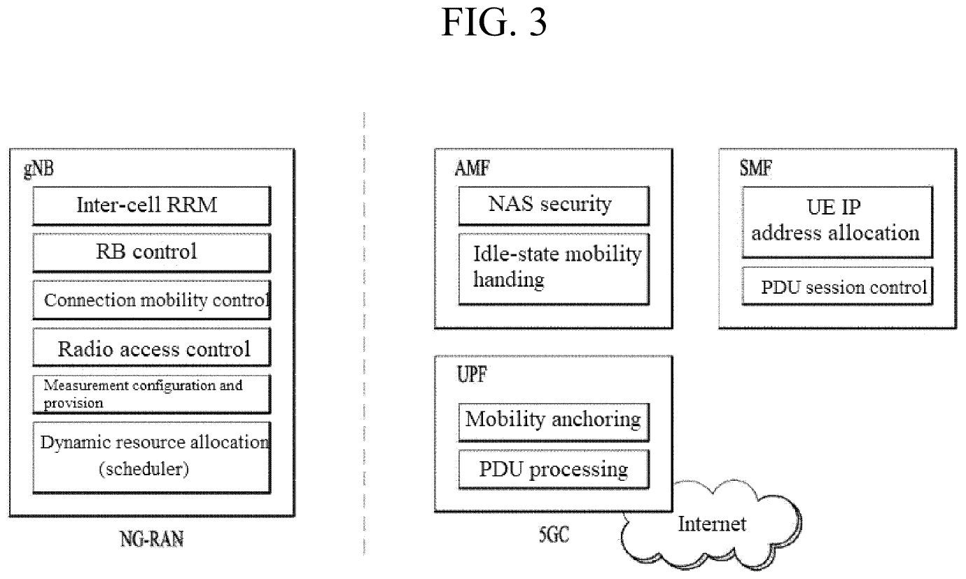

FIG. 3 illustrates functional split between a NG-RAN and a 5GC according to an embodiment of the present disclosure.

Referring to FIG. 3, a gNB may provide functions such as inter-cell radio resource management (Inter-Cell RRM), radio bearer control (RB Control), connection mobility control, radio admission control, measurement configuration and provision, and dynamic resource allocation. An AMF may provide functions such as NAS security and idle state mobility handling. A UPF may provide functions such as mobility anchoring and protocol data unit (PDU) processing. A session management function (SMF) may provide functions such as terminal Internet protocol (IP) address allocation and PDU session control.

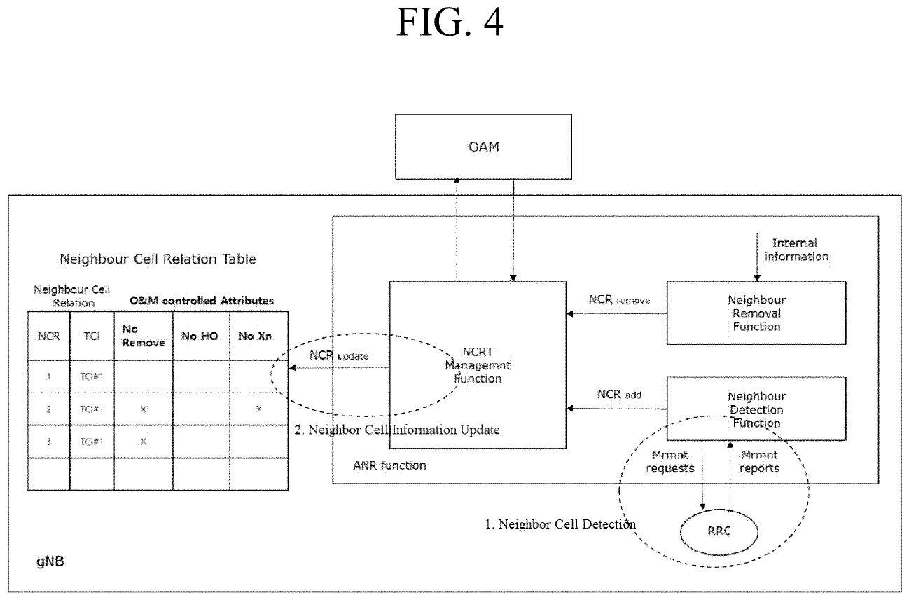

FIG. 4 is a diagram for explaining a conventional automatic neighbor relation (ANR) function.

Referring to FIG. 4, the conventional ANR includes a process of receiving information on neighboring cells detected by the UE through the RRC layer and a process of updating the received information on the neighboring cells.

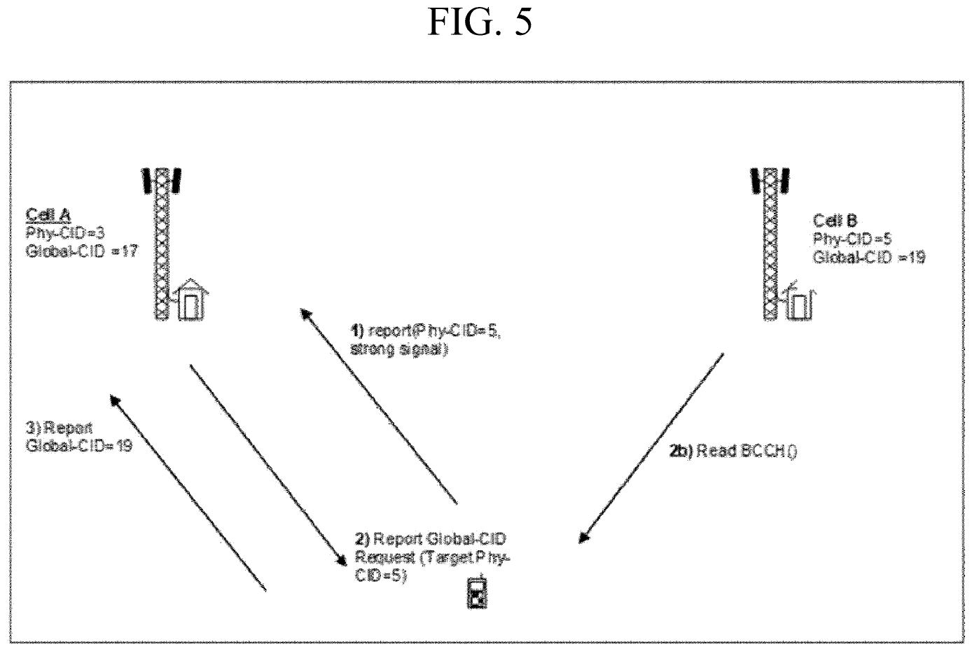

FIGS. 5 and 6 illustrate a process of detecting neighboring cells among the aforementioned processes.

Referring to FIGS. 5 and 6, a UE may transmit information on the signal strength of cell B to cell A through a measurement report process. In this case, the UE may also transmit the physical cell ID of cell B along with the signal strength information. For example, the UE may transmit information on the signal strength of cell B to cell A, along with the physical cell ID of cell B (i.e., Phy-CID=5).

If the information on cell B (i.e., Phy-CID=5) does not exist in a neighbor cell relation table (NCRT) managed by cell A, cell A may request the UE to perform a new measurement report configuration to detect the global cell ID of cell B for updating the NCRT.

In this case, the UE may receive a broadcast message from cell B and detect the global cell ID of cell B from that broadcast message. The UE may then report the detected global cell ID of cell B to cell A.

In the present disclosure, a new process for detecting neighboring cells will be described with reference to the descriptions of FIGS. 4 to 6. For example, if the UE is moving in the air, the UE may report to cell A that the UE is operating in the air, thereby allowing cell A or the BS associated with cell A to manage the NCRT by distinguishing between non-terrestrial and terrestrial networks.

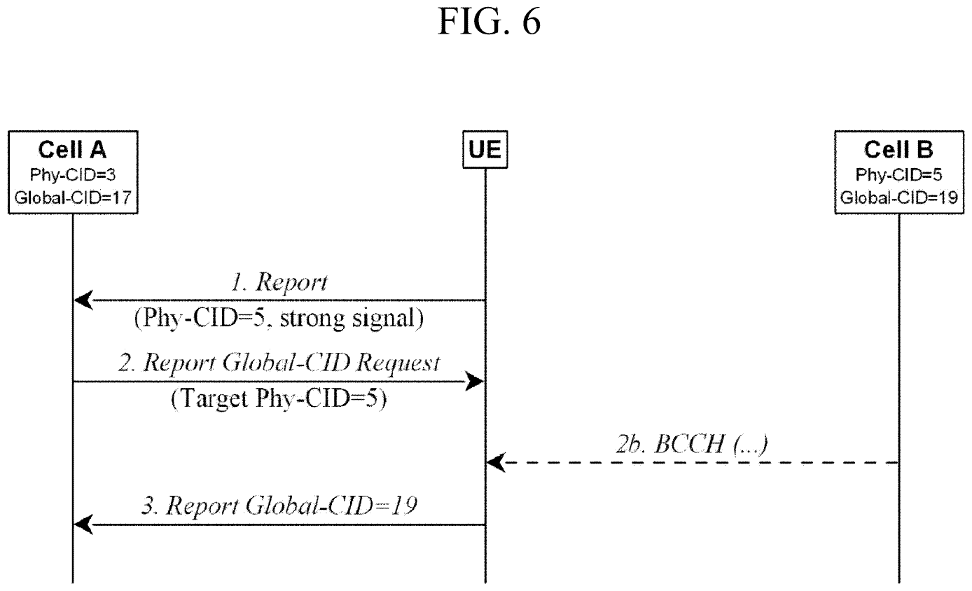

FIG. 7 is a diagram for explaining a process of detecting neighboring cells according to an embodiment of the present disclosure.

Referring to FIG. 7, steps 1 and 2 are the same as described in FIGS. 5 and 6. That is, the UE may transmit information on the signal strength of cell B to cell A through a measurement report process. In this case, the UE may also transmit the physical cell ID of cell B along with the signal strength information. For example, the UE may transmit information on the signal strength of cell B to cell A, along with the physical cell ID of cell B (i.e., Phy-CID=5).

If the information on cell B (i.e., Phy-CID=5) does not exist in an NCRT managed by cell A, cell A may request the UE to perform a new measurement report configuration to detect the global cell ID of cell B for updating the NCRT.

The process of detecting neighboring cells according to the embodiment of the present disclosure may further include providing additional aerial operation information to cell A in step 3 of FIG. 7.

For example, the UE may receive a broadcast message from cell B and detect the global cell ID of cell B from the broadcast message. The UE may report the detected global cell ID of cell B to cell A along with information on the aerial operation of the UE.

The information on the aerial operation of the UE may include at least one of the following three pieces of information.

1) Altitude information: Information on the current altitude of the UE may be provided to assist the network in managing the NCRT depending on the altitude.

2) Signal strength measurement information: The signal strength of cell B at the current location of the UE may be measured. Then, the measurement information may be transmitted to cell A. Accordingly, the UE may assist the network in determining whether cell B is suitable to be added as a neighboring cell based on the signal strength of cell B depending on the altitude.

The signal strength measurement information may be either the reference signal received power (RSRP) or the received signal strength indicator (RSSI).

3) Signal strength duration: When non-terrestrial cells or non-terrestrial UEs are used, the signal strength may fluctuate rapidly. Thus, duration information on how long the signal strength included in the measurement report is sustained may be provided to assist the network in determining whether cell B is temporarily measured by the UE and is not suitable as a service cell or whether cell B is consistently measured over a period of time and is suitable as a service cell.

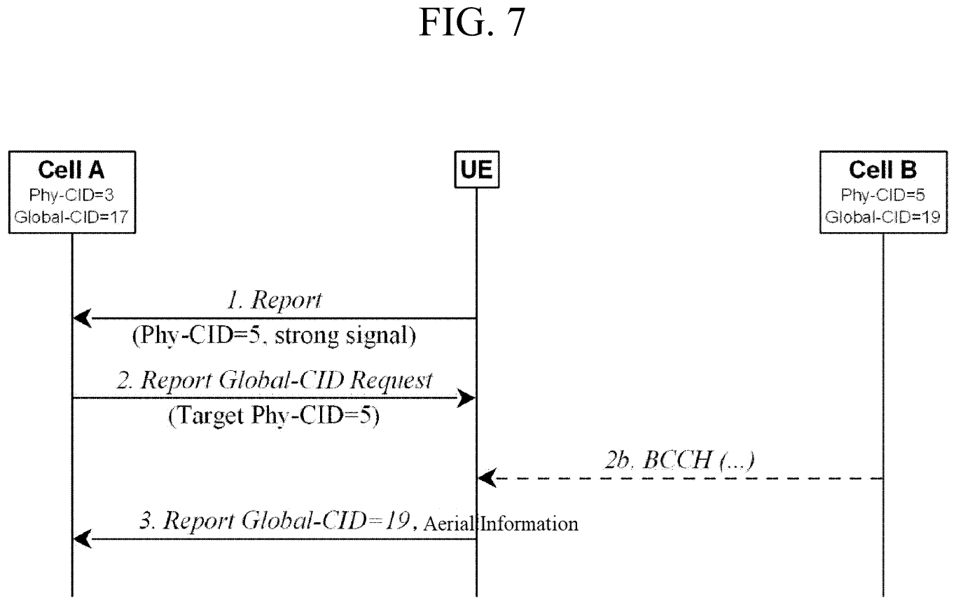

FIG. 8 illustrates a method by which cell A updates a new NCRT based on information obtained from the new process of detecting neighboring cells according to the embodiment of the present disclosure described above in FIG. 7.

In other words, FIG. 8 illustrates a method by which cell A updates the NCRT based on information on the aerial operation of the UE obtained from the process in FIG. 7.

Referring to FIG. 8, the method of updating the NCRT according to an embodiment of the present disclosure may include adding altitude information to the existing NCRT. Thus, even for the same Phy-cell ID, the attributes such as “No HO,” “No Xn,” and “No Removal” may vary depending on the altitude.

For example, in a terrestrial network, if the Phy-cell ID is 1, “No HO” is marked as “X.” That is, a handover (HO) is allowed. However, in a non-terrestrial network, due to different cell coverage characteristics, “No HO” may be changed to “O.” Therefore, when the network decides on the HO, the network may determine whether to perform the HO to a cell with a Phy-cell ID of 1 based on the altitude of the UE.

As another example, the addition of an Xn interface may vary depending on the altitude of the UE. For instance, the Xn interface may not be necessary on the ground, but if the Xn interface is required in non-terrestrial scenarios where the altitude is higher, the Xn interface may be added compared to the terrestrial network.

Examples of altitude information included in the NCRT may be as follows.

1) Absolute altitude information: The absolute altitude information may be represented as (0 m, 100 m), which indicates that the altitude of the UE ranges from 0 m to 100 m.

2) Altitude level information: The altitude level information may be represented by altitude levels such as H1 and H2. In this case, the absolute altitude range for each level may be managed separately by operations and maintenance (O&M).

FIG. 9 is a diagram for explaining a method of determining whether to add aerial operation information to an NCRT when the NCRT is updated according to FIG. 8. For example, in the case of non-terrestrial altitudes, channel fluctuations are significant. Thus, only when it is determined that sufficient signal strength is maintained for an adequate period by assessing a duration for which a signal is measured, the altitude may be added to the NCRT.

For example, referring to FIG. 9, the UE transmits the Phy-cell ID and/or global cell ID of cell B, along with information on the signal strength and signal duration. When cell A receives the information, cell A may determine whether the signal strength of cell B exceeds a first threshold (S901). If the signal strength does not exceed the first threshold, cell A may not add the corresponding altitude information to the NCRT (S903).

If the signal strength exceeds the first threshold, cell A may determine whether the duration for which the signal strength exceeds the first threshold surpasses a second threshold (S905). If the signal duration does not exceed the second threshold, cell A may not add the corresponding altitude information to the NCRT (S907).

If the signal duration exceeds the second threshold, cell A may add the corresponding altitude information to the NCRT (S909).

In other words, if the signal strength of cell B exceeds the first threshold and the duration for which the strength is measured above the first threshold exceeds the second threshold, cell A may add the corresponding altitude information to the NCRT.

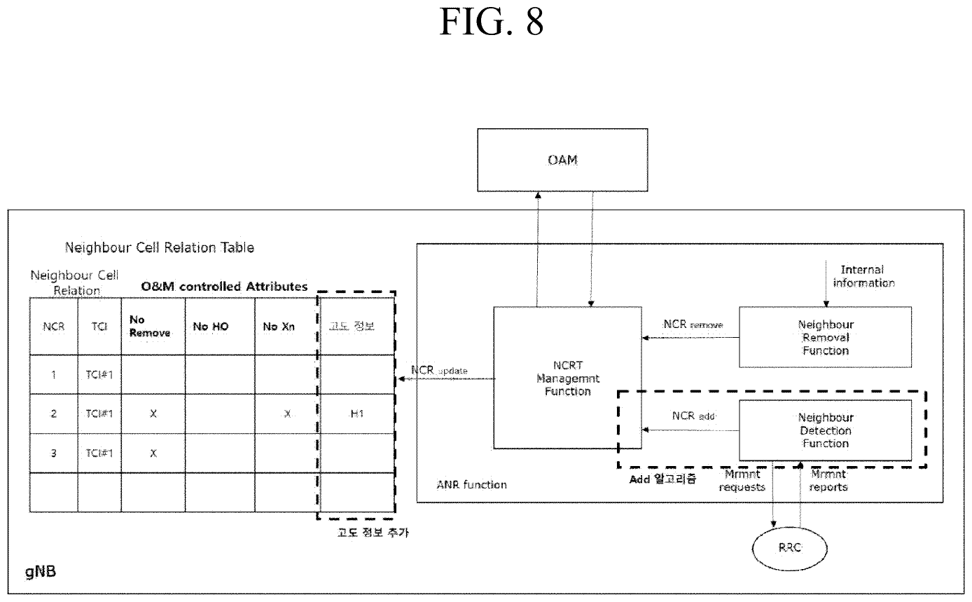

FIG. 10 illustrates wireless devices applicable to the present disclosure.

Referring to FIG. 10, a first wireless device 100 and a second wireless device 200 may transmit and receive radio signals through various radio access technologies (e.g., LTE, NR, etc.). In this case, {first wireless device 100, second wireless device 200} may correspond to the {UE, cell (cell A or cell B)} in the embodiments described in the present disclosure.

The first wireless device 100 includes one or more processors 102 and one or more memories 104. Additionally, the first wireless device 100 may include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including instructions for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement radio communication technologies (e.g., LTE, NR, etc.). The transceiver(s) 106 may be connected to the processor(s) 102 and transmit and/or receive radio signals through the one or more antennas 108. The transceiver(s) 106 may include a transmitter and/or a receiver. The transceiver(s) 106 may be interchangeably used with radio frequency (RF) unit(s). In the present disclosure, the wireless device may represent a communication modem/circuit/chip.

Hereinafter, the operations of the first wireless device 100 performed under the control of the one or more processors 102 will be described.

According to an embodiment of the present disclosure, the processor(s) 102 may control the transceiver(s) 106 to transmit information about the signal strength of cell B to cell A through a measurement report process. In this case, the processor(s) 102 may also control the transceiver(s) 106 to transmit the physical cell ID of cell B along with the signal strength information. For example, the processor(s) 102 may control the transceiver(s) 106 to transmit the information about the signal strength of cell B to cell A, along with the physical cell ID of cell B (i.e., Phy-CID=5).

If the information on cell B (i.e., Phy-CID=5) does not exist in an NCRT managed by cell A, the processor(s) 102 may control the transceiver(s) 106 to receive a request for a new measurement report configuration from cell A to detect the global cell ID of cell B for updating the NCRT.

The process of detecting neighboring cells according to the embodiment of the present disclosure may further include providing additional aerial operation information to cell A.

For example, the processor(s) 102 may control the transceiver(s) 106 to receive a broadcast message from cell B. The processor(s) 102 may then detect the global cell ID of cell B from the broadcast message. In addition, the processor(s) 102 may control the transceiver(s) 106 to report the detected global cell ID of cell B to cell A, along with information on the aerial operation of the UE.

The information on the aerial operation of the UE may include at least one of the following three pieces of information.

1) Altitude information: Information on the current altitude of the UE may be provided to assist the network in managing the NCRT depending on the altitude.

2) Signal strength measurement information: The signal strength of cell B at the current location of the UE may be measured. Then, the measurement information may be transmitted to cell A. Accordingly, the UE may help the network determine whether cell B is suitable to be added as a neighboring cell based on the signal strength of cell B depending on the altitude. The signal strength measurement information may be either the RSRP or RSSI.

3) Signal strength duration: When non-terrestrial cells or non-terrestrial UEs are used, the signal strength may fluctuate rapidly. Thus, duration information on how long the signal strength included in the measurement report is sustained may be provided to assist the network in determining whether cell B is temporarily measured by the UE and is not suitable as a service cell or whether cell B is consistently measured over a period of time and is suitable as a service cell.

The second wireless device 200 includes one or more processors 202 and one or more memories 204. Additionally, the second wireless device 200 may include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 206 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including instructions for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement radio communication technologies (e.g., LTE, NR, etc.). The transceiver(s) 206 may be connected to the processor(s) 202 and transmit and/or receive radio signals through the one or more antennas 208. The transceiver(s) 206 may include a transmitter and/or a receiver. The transceiver(s) 206 may be interchangeably used with RF unit(s). In the present disclosure, the wireless device may represent a communication modem/circuit/chip.

Hereinafter, the operations of the second wireless device 200 performed under the control of the one or more processors 202 will be described.

The processor(s) 202 may control the transceiver(s) 206 to receive information about the signal strength of cell B from the UE through a measurement report process. In this case, the processor(s) 202 may control the transceiver(s) 206 to receive the physical cell ID of cell B along with the signal strength information. For example, the processor(s) 202 may control the transceiver(s) 206 to receive information about the signal strength of cell B along with the physical Cell ID of Cell B (i.e., Phy-CID=5) from the UE.

If the information about cell B (i.e., Phy-CID=5) does not exist in an NCRT managed by the processor(s) 202, the processor(s) 202 may control the transceiver(s) 206 to request the UE to perform a new measurement report configuration to detect the global cell ID of cell B for updating the NCRT.

The process of detecting neighboring cells according to the embodiment of the present disclosure may further include providing additional aerial operation information to the processor(s) 202.

For example, the processor(s) 202 may receive information on the aerial operation of the UE along with the detected global cell ID of cell B from the UE via the transceiver(s) 206.

The information on the aerial operation of the UE may include at least one of the following three pieces of information.

1) Altitude information: Information on the current altitude of the UE may be provided to assist the network in managing the NCRT depending on the altitude.

2) Signal strength measurement information: The signal strength of cell B at the current location of the UE may be measured. Then, the measurement information may be transmitted to cell A. Accordingly, the UE may help the network determine whether cell B is suitable to be added as a neighboring cell based on the signal strength of cell B depending on the altitude. The signal strength measurement information may be either the RSRP or RSSI.

3) Signal strength duration: When non-terrestrial cells or non-terrestrial UEs are used, the signal strength may fluctuate rapidly. Thus, duration information on how long the signal strength included in the measurement report is sustained may be provided to assist the network in determining whether cell B is temporarily measured by the UE and is not suitable as a service cell or whether cell B is consistently measured over a period of time and is suitable as a service cell.

Accordingly, when updating the NCRT, the processor(s) 202 may add altitude information to the existing NCRT. Therefore, even for the same Phy-cell ID, the attributes such as “No HO,” “No Xn,” and “No Removal” may vary depending on the altitude.

For example, in a terrestrial network, if the Phy-cell ID is 1, “No HO” is marked as “X.” That is, HO is allowed. However, in a non-terrestrial network, due to different cell coverage characteristics, “No HO” may be changed to “O.” Therefore, when the processor(s) 202 decides on the HO, the processor(s) 202 may determine whether to perform the HO to a cell with a Phy-cell ID of 1 based on the altitude of the UE.

As another example, the addition of an Xn interface may vary depending on the altitude of the UE. For instance, the Xn interface may not be necessary on the ground, but if the Xn interface is required in non-terrestrial scenarios where the altitude is higher, the processor(s) 202 may add the Xn interface compared to the terrestrial network.

Examples of altitude information included in the NCRT may be as follows.

1) Absolute altitude information: The absolute altitude information may be represented as (0 m, 100 m), which indicates that the altitude of the UE ranges from 0 m to 100 m.

2) Altitude level information: The altitude level information may be represented by altitude levels such as H1 and H2. In this case, the absolute altitude range for each level may be managed separately by O&M.

When the processor(s) 202 updates the NCRT, the processor(s) 202 may add the aerial operation information to the NCRT if specific conditions are met. For example, in the case of non-terrestrial altitudes, channel fluctuations are significant. Thus, only when it is determined that sufficient signal strength is maintained for an adequate period by assessing a duration for which a signal is measured, the altitude may be added to the NCRT.

For example, referring to FIG. 9, the UE transmits the Phy-cell ID and/or global cell ID of cell B, along with information on the signal strength and signal duration. By controlling the transceiver(s) 206 to receive the information, the processor(s) 202 may determine whether the signal strength of cell B exceeds a first threshold. If the signal strength does not exceed the first threshold, the processor(s) 202 may not add the corresponding altitude information to the NCRT.

If the signal strength exceeds the first threshold, the processor(s) 202 may determine whether the duration for which the signal strength exceeds the first threshold surpasses a second threshold. If the signal duration does not exceed the second threshold, the processor(s) 202 may not add the corresponding altitude information to the NCRT.

If the signal duration exceeds the second threshold, the processor(s) 202 may add the corresponding altitude information to the NCRT.

In other words, if the signal strength of cell B exceeds the first threshold and the duration for which the strength is measured above the first threshold exceeds the second threshold, the processor(s) 202 may add the corresponding altitude information to the NCRT.

Hereinafter, the hardware elements of the wireless devices 100 and 200 will be described in more detail. One or more protocol layers may be implemented by the one or more processors 102 and 202. However, the present disclosure is not limited thereto. For example, the one or more processors 102 and 202 may implement one or more layers (e.g., functional layers such as PHY, MAC, RLC, PDCP, RRC, SDAP, etc.). The one or more processors 102 and 202 may generate one or more PDUs and/or one or more service data units (SDUs) according to the descriptions, functions, procedures, proposals, methods, and/or operation flowcharts disclosed in this document. The one or more processors 102 and 202 may generate messages, control information, data, or other information according to the descriptions, functions, procedures, proposals, methods, and/or operation flowcharts disclosed in this document. The one or more processors 102 and 202 may generate signals (e.g., baseband signals) that include PDUs, SDUs, messages, control information, data, or other information according to the functions, procedures, proposals, and/or methods disclosed in this document and provide the signals to the one or more transceivers 106 and 206. The one or more processors 102 and 202 may receive signals (e.g., baseband signals) from one or more transceivers 106 and 206 and acquire PDUs, SDUs, messages, control information, data, or other information according to the descriptions, functions, procedures, proposals, methods, and/or operation flowcharts disclosed in this document.

The one or more processors 102 and 202 may be referred to as a controller, microcontroller, microprocessor, or microcomputer. The one or more processors 102 and 202 may be implemented through hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be designed to include modules, procedures, functions, and so on. The firmware or software configured to perform the descriptions, functions, procedures, proposals, methods, and/or operation flowcharts disclosed in this document may be included in the one or more processors 102 and 202 or stored in the one or more memories 104 and 204 and driven by the one or more processors 102 and 202. The descriptions, functions, procedures, proposals, methods, and/or operation flowcharts disclosed in this document may be implemented using firmware or software in the form of code, instructions, and/or sets of instructions.

The one or more memories 104 and 204 may be connected to the one or more processors 102 and 202 and may store various forms of data, signals, messages, information, programs, code, instructions, and/or commands. The one or more memories 104 and 204 may be implemented with ROM, RAM, EPROM, flash memory, hard drives, registers, cache memory, computer-readable storage media, and/or combinations thereof. The one or more memories 104 and 204 may be located internally and/or externally to the one or more processors 102 and 202. Additionally, the one or more memories 104 and 204 may be connected to the one or more processors 102 and 202 through various technologies such as wired or wireless connections.

The one or more transceivers 106 and 206 may transmit user data, control information, radio signals/channels, and so on mentioned in the methods and/or operation flowcharts of this document, to one or more other devices. The one or more transceivers 106 and 206 may receive user data, control information, radio signals/channels, and so on mentioned in the descriptions, functions, procedures, proposals, methods, and/or operation flowcharts disclosed in this document, from one or more other devices. For example, the one or more transceivers 106 and 206 may be connected to the one or more processors 102 and 202 and may transmit and receive radio signals. For example, the one or more processors 102 and 202 may control the one or more transceivers 106 and 206 to transmit user data, control information, or radio signals to one or more other devices. The one or more processors 102 and 202 may control the one or more transceivers 106 and 206 to receive user data, control information, or radio signals from one or more other devices. Furthermore, the one or more transceivers 106 and 206 may be connected to the one or more antennas 108 and 208 and be configured to transmit and receive user data, control information, radio signals/channels, and so on, which are mentioned in the descriptions, functions, procedures, proposals, methods, and/or operation flowcharts disclosed in this document, via the one or more antennas 108 and 208. In this document, the one or more antennas may be multiple physical antennas or multiple logical antennas (e.g., antenna ports). The one or more transceivers 106 and 206 may convert received radio signals/channels from RF band signals to baseband signals to allow the one or more processors 102 and 202 to process the received user data, control information, radio signals/channels, and so on. The one or more transceivers 106 and 206 may convert user data, control information, radio signals/channels, and so on processed by the one or more processors 102 and 202 from baseband signals to RF band signals. To this end, the one or more transceivers 106 and 206 may include (analog) oscillators and/or filters.

FIG. 11 illustrates a vehicle or an autonomous vehicle applicable to the present disclosure. The vehicle or autonomous vehicle may be implemented as a mobile robot, car, train, manned/unmanned aerial vehicle (AV), ship, and so on.

Referring to FIG. 11, the vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as part of the communication unit 110. Blocks 110/130/140a to 140d correspond to blocks 110/130/140 in FIG. 12, respectively.

The communication unit 110 may transmit and receive signals (e.g., data and control signals) with external devices such as other vehicles, BSs (e.g., gNB, roadside BS (road side unit)), servers, and so on. The control unit 120 may control components of the vehicle or autonomous vehicle 100 to perform a variety of operations. The control unit 120 may include an electronic control unit (ECU). The driving unit 140a enables the vehicle or autonomous vehicle 100 to drive on the ground. The driving unit 140a may include an engine, a motor, a powertrain, a wheel, a brake, a steering system, and so on. The power supply unit 140b provides power to the vehicle or autonomous vehicle 100 and may include wired/wireless charging circuits, batteries, and so on. The sensor unit 140c may acquire information on a vehicle condition, surrounding environment, and user. The sensor unit 140c may include various sensors such as an inertial measurement unit (IMU) sensor, collision sensor, wheel sensor, speed sensor, incline sensor, weight detection sensor, heading sensor, position module, vehicle forward/reverse sensor, battery sensor, fuel sensor, tire sensor, steering sensor, temperature sensor, humidity sensor, ultrasonic sensor, light sensor, pedal position sensor, and so on. The autonomous driving unit 140d may implement a technology for maintaining the lane while driving, a technology for automatically adjusting the speed such as adaptive cruise control, a technology for automatically driving along a predetermined route, and a technology for automatically planning and following a route when a destination is set.

For example, the communication unit 110 may receive map data, traffic information data, and so on from an external server. The autonomous driving unit 140d may generate an autonomous driving route and driving plan based on the acquired data. The control unit 120 may control the driving unit 140a to ensure that the vehicle or autonomous vehicle 100 follows the autonomous driving route according to the driving plan (e.g., speed/direction adjustment). During autonomous driving, the communication unit 110 may periodically or aperiodically acquire the latest traffic information data from the external server and obtain surrounding traffic information data from neighboring vehicles. In addition, during autonomous driving, the sensor unit 140c may acquire information about the vehicle condition and surrounding environment. The autonomous driving unit 140d may update the autonomous driving route and driving plan based on the newly acquired data/information. The communication unit 110 may transmit information on the vehicle location, autonomous driving route, and driving plan to the external server. The external server may use the artificial intelligence (AI) technology to predict traffic information data based on information collected from vehicles or autonomous vehicles and provide the predicted traffic information data to the vehicles or autonomous vehicles.

FIG. 12 illustrates a vehicle applicable to the present disclosure. The vehicle may also be implemented as a means of transportation such as a train, aircraft, or ship.

Referring to FIG. 12, a vehicle (100) may include a communication unit (110), a control unit (120), a memory unit (130), an input/output unit (140a), and a positioning unit (140b). Herein, blocks 110 to 130/140a to 140b correspond to blocks 110 to 130/140 in FIG. 11, respectively.

The communication unit 110 may transmit and receive signals (e.g., data and control signals) to and from external devices such as other vehicles or BSs. The control unit 120 may perform various operations by controlling components of the vehicle 100. The memory unit 130 may store data/parameters/programs/code/instructions for supporting various functions of the vehicle 100. The input/output unit 140a may output an AR/VR object based on information within the memory unit 130. The input/output unit 140a may include a head-up display (HUD). The positioning unit 140b may acquire information about the position of the vehicle 100. The position information may include information about the absolute position of the vehicle 100, information about the position of the vehicle 100 within a driving lane, acceleration information, and information about the position of the vehicle 100 relative to surrounding vehicles. The positioning unit 140b may include a global positioning system (GPS) and various sensors

For example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information, and the input/output unit 140a may display the generated virtual object on a window in the vehicle (1410 and 1420). The control unit 120 may determine whether the vehicle 100 is operating correctly within the driving lane based on the vehicle position information. If the vehicle 100 deviates from the driving lane abnormally, the control unit 120 may display a warning on the window in the vehicle through the input/output unit 140a. In addition, the control unit 120 may broadcast a warning message regarding driving abnormality to neighboring vehicles through the communication unit 110. Depending on the situation, the control unit 120 may also transmit the vehicle position information and the information about the driving/vehicle abnormality to relevant authorities via the communication unit 110.

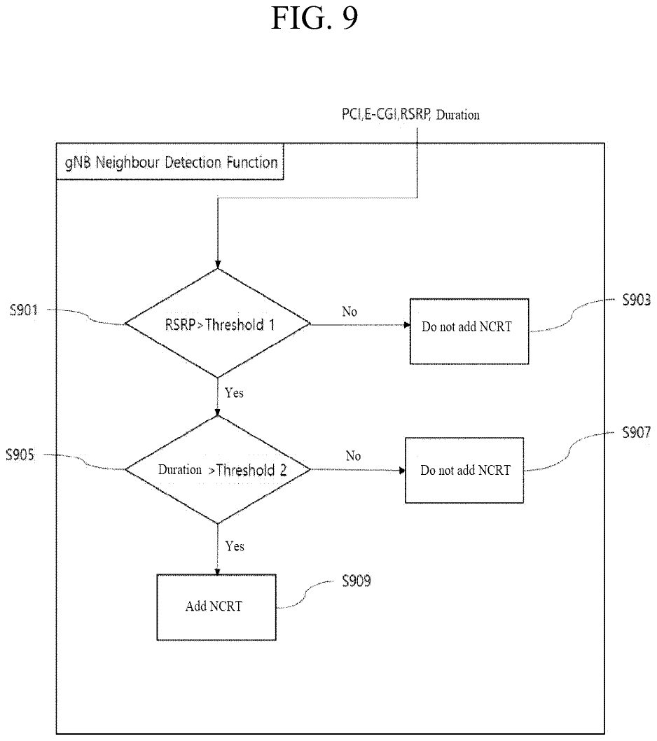

FIG. 13 is a block diagram for explaining a 5G NR system.

Referring to FIG. 13, the 5G system may include a UE 100, a BS 110, and a 5G core network 120 (hereinafter referred to as a 5GC or 5G core network). The 5G core network 120 may include the following network functions (hereinafter used interchangeably with the term NF): access and mobility management function (AMF) 121, session management function (SMF) 122, policy control function (PCF) 123, unified data management (UDM) 124, user plane function (UPF) 125, network slice selection function (NSSF) 126, network repository function (NRF) 127, service communication proxy (SCP) 128, network exposure function (NEF) 129, unified data repository (UDR) 130, binding support function (BSF) 131, and so on. Herein, a network function refer to a network entity (hereinafter used interchangeably with the term NE) or network resources. The BS 110 may include a NG-RAN (hereinafter used interchangeably with the term 5G-RAN or RAN), an evolved universal terrestrial radio access network (E-UTRAN), and so on. The UE 100 (terminal) may connect to the 5G core network (120) through the BS 110.

Specifically, the AMF 121 is a network function that manages access to a radio network and mobility for the UE.

The SMF 122 is a network function that manages a packet data network connection provided to the UE. The packet data network connection may be referred to as a PDU session. PDU session information may include Quality of Service (QoS) information, charging information, packet processing information, etc.

The PCF 123 is a network function that applies the service policies, charging policies, and PDU session policies of the mobile operator to the UE.

The UPF 125 may serve as a gateway for transmitting packets transmitted and received by the UE and may be a network function controlled by the SMF. The UPF may be connected to a data network (DN) and may transmit uplink data packets generated by the UE to an external DN through the 5G system. In addition, the UPF may transmit downlink data packets generated by the external DN to the UE through the 5G system. For example, the UPF may be connected to a DN that is linked to the Internet. That is, the UPF may route data packets transmitted by the UE to the Internet and route data packets transmitted from the Internet to the UE. The UDM 124 may be a network function that stores and manages information about subscribers.

The NEF 129 is a network function that has access to information for managing the UE in the 5G network. The NEF 129 may be connected with NFs of the 5G core network through the following operations: subscribing to mobility management events of the UE, subscribing to session management events of the UE, requesting session-related information, configuring charging information for the UE, and requesting changes to the PDU session policy for the UE, thereby providing information about the UE or reporting UE-related information externally.

The UDR 130 may be a network function that stores and manages data. For example, the UDR may store UE subscription information and provide the UE subscription information to the UDM. The UDR may store operator policy information and provide the operator policy information to the PCF. The UDR may store information related to network service exposure and provide the information related to network service exposure to the NEF.

The NSSF 126 may be a network function that determines network slices available to the UE and selects network slice instances that constitute the network slices. Each NF defines services provided by the NF, and the services provided by the NF may be referred to as Npcf, Nsmf, Namf, Nnef, and so on. For example, when the AMF transmits a session-related message to the SMF, the AMF may use a service (or application programming interface (API)) called Nsmf_PDUSession_CreateSMContext.

Application functions (AFs) 140 and 150 may be a network function capable of using the services and capabilities provided by the 5G network. In addition, the AF may also function as an application server. Specifically, the AF 150 may communicate with the NFs of the 5G core network 120 through the NEF 129. Alternatively, the AF 140 may directly communicate with the NFs of the 5G core network without the NEF 129. Moreover, the AFs 140 and 150 may be located within the 5G core network or in an external network (for example, an unmanned aerial system traffic management (UTM) server that provides UAM services).

The UE 100 connects to the AMF 121 through the BS 110 and may exchange control plane signaling messages with the 5G core network. Additionally, the UE 100 connects to the UPF 125 through the BS 110 and may exchange user plane data with the DN. An application server that provides application layer services to the UE may be referred to as the AF when exchanging control plane signaling messages with the 5G core network. In addition, the application server may be referred to as the DN when exchanging user plane data with the UE. Furthermore, the terms AF and DN may be used interchangeably to refer to the application server.

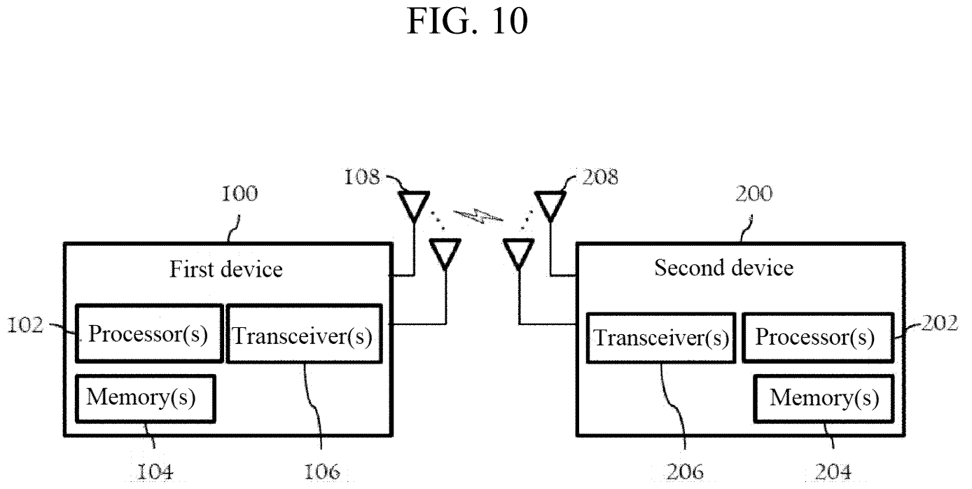

FIG. 14 is a diagram for explaining network slicing.

Referring to FIG. 14, network slicing is a method of forming a virtualization layer applied to wireless network services, where multiple logical networks are configured on a single physical network. In other words, network slicing is a network architecture that enables the creation of multiple, independent, virtualized logical networks on the same physical network infrastructure. Each network slice (or slice) is a separate end-to-end network tailored to meet the various requirements requested by a specific application. As a cloud or container server is not merely a physical server but a virtualized entity, in a network, independent logical networks may be created within a large physical network based on automated bandwidth allocation, QoS rules, and other network functions.

Specifically, a wireless communication system may be configured as a network that supports network slicing. In other words, in a mobile communication system, a single physical network may be logically separated into network slices (or slices), which may be configured and managed independently. A mobile network operator may provide dedicated network slices specialized for various services with different characteristics. Each network slice may require different types and amounts of resources depending on the service characteristics, and the mobile communication system may ensure the resources required by each network slice. For example, a network slice providing voice call services may have a high frequency of control plane signaling, and the network slice may be configured with a NF specialized for this purpose. A network slice providing internet data services may have a high frequency of large data traffic, and the network slice may be configured with a NF specialized for this purpose.

In the 5G system defined by 3GPP, a network slice may be referred to as single-network slice selection assistance information (S-NSSAI). The S-NSSAI may include a slice/service type (SST) value and a slice differentiator (SD) value. The SST may indicate the characteristics of the service supported by the slice (for example, eMBB, IoT, URLLC, V2X, UAM, etc.). The SD may be a value used as an additional identifier for a specific service referred to by the SST.

Network slice selection assistance information (NSSAI) may consist of one or more pieces of S-NSSAI. For example, the NSSAI include configured NSSAI stored in the UE, requested NSSAI requested by the UE, allowed NSSAI determined by network functions (e.g., AMF, NSSF, etc.) in the 5G core network and permitted for the UE to use, and subscribed NSSAI that the UE is subscribed to. However, the present disclosure is not limited thereto. The S-NSSAI included in slice policy information may be an identifier representing the slice. A mobile network operator may also use a network slice instance (NSI) ID as the identifier for the slice, instead of the S-NSSAI.

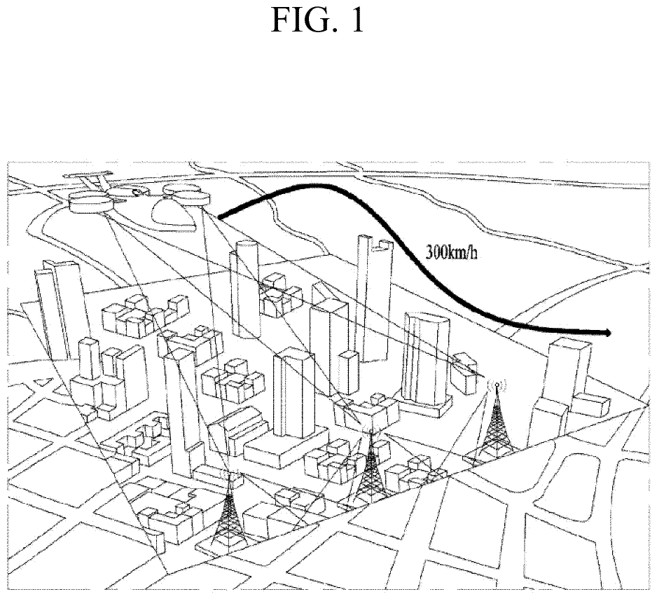

As explained with reference to FIG. 1, the communication environment for UAM services differs from that of ground-based wireless communication. Therefore, it is necessary to configure a slice corresponding to the UAM services and provide a wireless communication environment suitable for the UAM services based on the slice.

For example, a network may configure or allocate slice types in advance as follows: a slice type for eMBB (SST=1), a slice type for URLLC (SST=2), a slice type for massive IoT (MIOT) (SST=3), a slice type for vehicle-to-everything (V2X) (SST=4), a slice type for high-performance machine-type communications (HMTC) (SST=5), and a slice type for UAM (SST=6).

Hereinafter, a method by which a network and/or BS identifies a first UE installed in a UAM device (e.g., air taxi, flying taxi, etc.) that provides a UAM service when a slice corresponding to the UAM service is configured and/or a method by which the network and/or BS forms a slice for the identified first UE will be described.

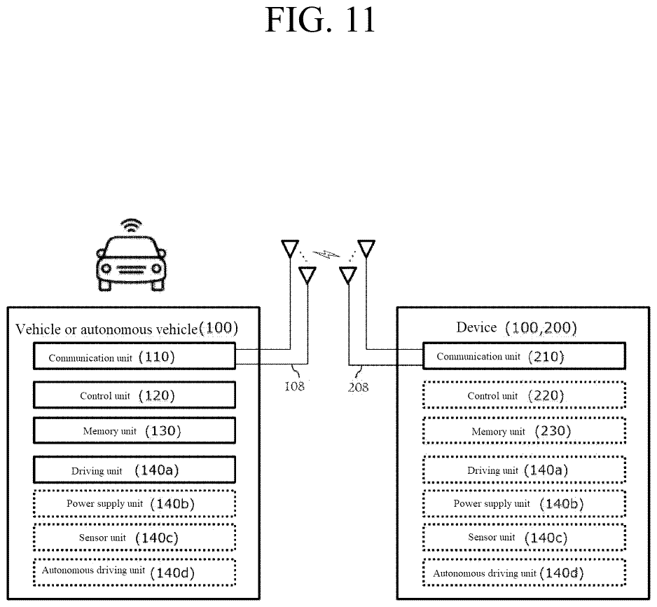

FIG. 15 is a diagram for explaining a method by which a first UE mounted in a UAM device performs an authentication procedure with a UAM UE.

Referring to FIG. 15, when a first UE 100 is installed in a UAM device 102, the first UE 100 may perform an authentication procedure related to a UAM service with a UAM UE 103 included in the UAM device. For example, the first UE 100 may perform the authentication procedure with the UAM UE 103 based on an authentication procedure through an application related to the UAM service. Alternatively, the first UE 100 may use proximity communication such as near field communication (NFC) or Bluetooth to perform the authentication procedure with the UAM UE 103 through the application. Alternatively, the first UE 100 may use tethering or a hotspot based on WiFi or Bluetooth to perform the authentication procedure with the UAM UE 103 through the application. Alternatively, the first UE 100 may establish a sidelink (or device-to-device (D2D) communication) with the UAM UE 103 based on LTE or 5G communication and perform the authentication procedure through the application via the sidelink. The first UE 100 may also perform the authentication procedure with the UAM UE 103 through the application using other forms of communication methods besides the ones described. The authentication procedure through the application is not limited to the examples mentioned above.

The first UE 100 may configure or generate slice information including a slice ID related to the UAM service through the authentication procedure with the UAM UE 103. The first UE 100 may transmit a first message including the slice information to a BS 40 to request the formation of a slice for the UAM service. In this case, the slice information may include S-NSSAI for the UAM service, and the S-NSSAI may include information on a new slice type for the UAM service. Alternatively, the slice information may include at least one a quality class identifier (QCI), a service profile identifier (SPID), or the slice ID (S-NSSAI) allocated for the UAM service.

The BS 40 may form the slice corresponding to the slice information for the first UE 100 based on the slice information included in the first message. In addition, the BS 40 may forward the first message containing the slice information and/or the slice information to an AMF/mobility management entity (MME) 121. In this case, the AMF/MME 121 may identify the first UE related to the UAM service based on the slice information and support the formation of the slice related to the UAM service for the first UE.

The BS 40 and AMF/MME 121 may pre-agree on or pre-configure the support of the slice ID, an SST, and other parameters corresponding to the UAM service. In this case, the BS 40 and AMF/MME 121 may quickly form the slice with the first UE 100 based on the slice ID and SST included in the slice information.

The UAM UE 103 may obtain authentication information on the UE 100 through an application authentication procedure for the UE 100. The authentication information may include UE identification information on the UE 100 and/or user identification information on the user of the UE 100. For example, the UE identification information may include information on the UE ID, international mobile subscriber identity (IMSI), international mobile equipment identity (IMEI), operator, and phone number of the UE 100. The user identification information may include information on the resident registration number, name, address, and credit card of the user.

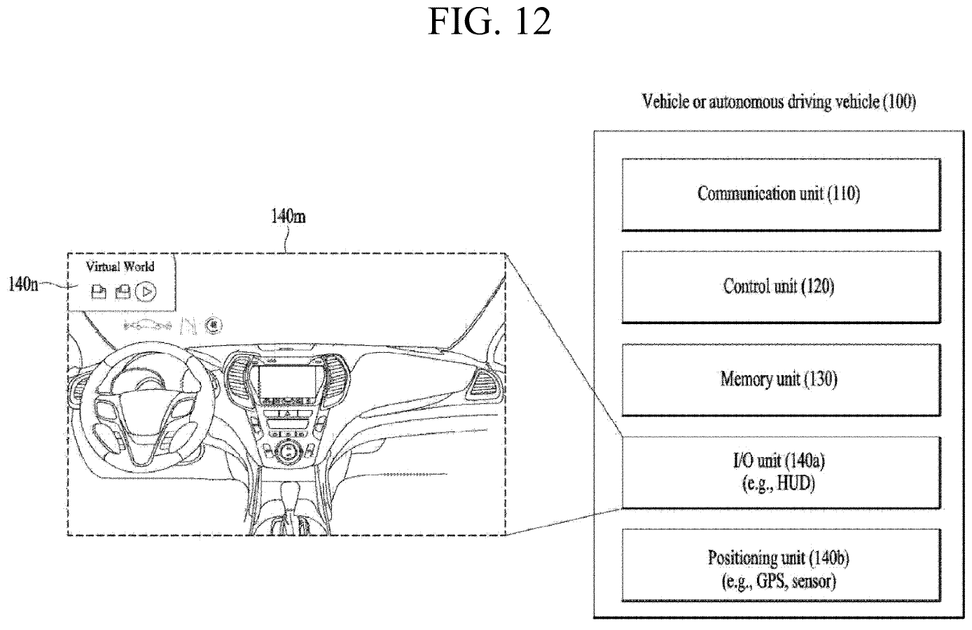

FIG. 16 is a diagram for explaining a method by which a first UE, a BS, and a network form a slice related to a UAM service.

Referring to FIG. 16, the BS and network may pre-configure the slice for the UAM service (S101). For example, the BS may perform a procedure of configuring the slice for the UAM service with the network (5G core network) through an AMF included in the network.

Through the configuration of the slice, the BS and network may agree to support a slice ID allocated for the UAM service. For example, the BS may agree with the AMF included in the network to support the slice ID allocated for the UAM service. Specifically, the BS and network may configure the value of an SST for the UAM service and pre-allocate the slice ID corresponding to the UAM service. In this case, the SST may be assigned a new value of 6 for the UAM service as shown in Table 1 below.

TABLE 1

| Slice/Service | SST | |
|---|---|---|
| type | value | Characteristics |
| eMBB | 1 | Slice suitable for the handing of 5G enhanced |
| | | Mobile Broadband |
| URLLC | 2 | Slice suitable for the handing of ultra-reliable low |
| | | latency communications |
| MIoT | 3 | Slice suitable for the handing of massive IoT |
| V2X | 4 | Slice suitable for the handing of V2X services |
| HMTC | 5 | Slice suitable for the handing of High-Performance |
| | | Machine-Type communications |
| UAM | 6 | Slice suitable for the handing of UAM |
| | | communication |

Specifically, the network and BS may allocate/configure S-NSSAI for the UAM service. The S-NSSAI, which is capable of identifying a single slice, may include the aforementioned SST value and an SD value. Here, the SD may be allocated differently for each entity providing the UAM service. In other words, the same SST value may be assigned for the UAM service, but different SD values may be allocated depending on the entity providing the UAM service.

In this way, the network and BS may pre-allocate/pre-configure the S-NSSAI for the UAM service. Then, if a UE using the UAM service is identified, the network and BS may provide wireless communication through the slice with the identified UE.

Next, the first UE may be installed in a UAM device and perform an authentication procedure through an application to use the UAM service with a UAM UE included in the UAM device (or with the UAM device) (S103). The authentication procedure may be carried out using proximity communication (NFC, Bluetooth), WiFi tethering, sidelink, or other methods between the first UE and the UAM UE. Through the authentication procedure, the UAM UE may obtain authentication information including identification information on the UE and/or the user thereof.

The first UE may configure slice information related to the UAM device or the UAM UE through the authentication procedure. Specifically, the first UE may configure the S-NSSAI for the UAM service through the authentication procedure. As described above, the S-NSSAI may include the SST value newly defined for the UAM service and the SD value for identifying the entity providing the UAM service (e.g., UTM server) via the UAM device.

Alternatively, the first UE may obtain QCI, SPID, and/or S-NSSAI values allocated for the UAM service through the authentication procedure and configure/generate the slice information that includes at least one of the QCI, SPID, and/or S-NSSAI values.

Next, the first UE may transmit a first message including the slice information to the BS to request the formation of the slice for the UAM service (S105).

Alternatively, if predetermined conditions are additionally satisfied, the first UE may transmit the first message to the BS. For example, after completing the authentication procedure, the first UE may monitor or measure information on the mobility and altitude of the first UE. The first UE may transmit the first message to the BS if the measured altitude exceeds a predetermined threshold altitude. For instance, the predetermined threshold altitude may be set to 100 m or higher. Alternatively, the first UE may transmit the first message if the speed from the measured mobility information exceeds a predetermined threshold speed. This is because the radio environment according to the UAM service may change significantly when the altitude and/or speed of the first UE is greater than or equal to a specific altitude and/or speed. Alternatively, even after completing the authentication procedure, the first UE may disembark without receiving the UAM service via the UAM device. This is to prevent the unnecessary formation of slices by the first UE. Alternatively, after transmitting the first message, if the altitude falls below the predetermined threshold altitude, the first UE may transmit a second message to the BS to release the formed slice.

Next, the BS/network may form the slice corresponding to the slice information included in the first message with the first UE (S107). While forming the slice, the BS/network may reconfigure at least one parameter for the first UE. For example, while forming the slice, the BS may reconfigure the at least one parameter for the first UE such that the value of time-to-trigger (TTT) or the range of a tracking area (TA) increases, thereby preventing frequent handovers. Alternatively, the BS may reconfigure the parameter to allow the first UE to continue communication with the UAM UE via the sidelink in response to the slice formation. Alternatively, the BS may adjust an antenna direction and/or beamforming direction in response to changes in the location of the UE that receives the UAM service.

Alternatively, the first UE may request the BS to provide the S-NSSAI (or UAM slice ID) allocated for the UAM service. For example, through the authentication procedure, the first UE may obtain information indicating that the UAM service is being used and information on an entity providing the UAM service. The first UE may then transmit the first message containing the obtained information to the BS to request the corresponding S-NSSAI from the BS or request the formation of the slice for the UAM service. In this case, the first UE may recognize that the slice for the UAM service is formed with the BS by receiving information on the S-NSSAI from the BS.

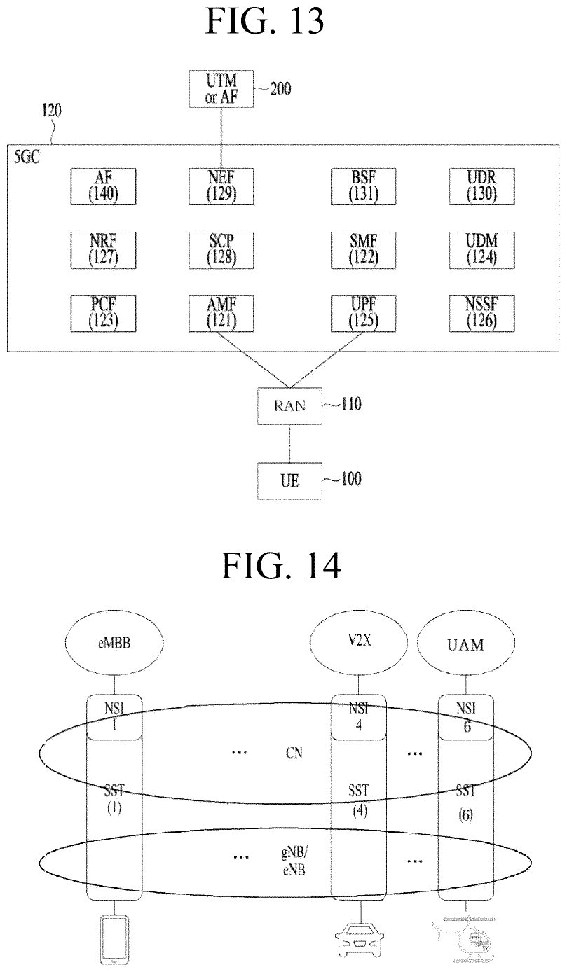

FIG. 17 is a flowchart for explaining a method by which a first UE requests a BS or network to form a slice related to a UAM service.

Referring to FIG. 17, the first UE may perform authentication with a UAM UE included in a UAM device to receive the UAM service (S81). The first UE may perform the authentication procedure through proximity communication, WiFi tethering, or sidelink communication with the UAM UE.

The first UE may obtain slice information on the slice related to the UAM service during the authentication procedure. Alternatively, the first UE may further obtain information such as operation details and information about the entity responsible for the operation related to the UAM service. Alternatively, the first UE may further obtain information on the operation and operating entity related to the UAM service.

During the authentication procedure, the UAM UE may obtain authentication information that includes identification information on the first UE and/or identification information on the user of the first UE. In this case, the identification information on the first UE may include a UE ID, IMSI, IMEI, operator, and phone number. The identification information on the user of the first UE may include a resident registration number, name, address, credit card, and so on. The UAM UE may transmit the authentication information to a UTM server that manages and operates the UAM service.

Next, the first UE may configure or generate slice information on the UAM service provided by the UAM UE or UAM device through the authentication procedure (S83). Specifically, the first UE may obtain S-NSSAI allocated for the UAM service through the authentication procedure and configure or generate the slice information including the S-NSSAI. As described above, the S-NSSAI may include an SST value allocated for the UAM service and an SD value for the operating entity.

Information on the S-NSSAI for configuring/generating the slice information may be information on S-NSSAI pre-allocated by the network and/or BS to the UAM device or UAM UE and pre-transmitted to the UAM device or UAM UE.

Next, the first UE may transmit a first message containing the slice information to the BS (S85). The first message may be a message that requests or triggers the formation of the slice related to the UAM service. Alternatively, as mentioned above, the first UE may determine the timing of transmitting the first message based on the altitude and/or speed. For example, the first UE may transmit the first message to the BS if the measured altitude is greater than or equal to a predetermined threshold altitude or if the measured speed is greater than or equal to a predetermined threshold speed. Alternatively, the first UE may also transmit the first message at the time when the configuration of the slice information is completed.

Alternatively, the first message may be a message requesting the S-NSSAI. In this case, the first UE may transmit the first message including information to specify the S-NSSAI (e.g., information indicating the UAM service, information on an entity providing the UAM service, etc.) to the BS,

Next, the first UE may form the slice corresponding to the UAM service with the BS through the transmission of the first message (S87). While forming the slice, the first UE may be reconfigured with the at least one parameter related to wireless communication. In other words, the first UE may be reconfigured with the at least one parameter related to the UAM service (or at least one parameter related to the slice for the UAM service). For example, the first UE may be reconfigured with a TTT value larger than that of ground UEs or a TA range broader than that of ground UEs to prevent frequent handovers. Alternatively, the first UE may be configured with the at least one parameter such that communication with the BS through sidelink communication with the UAM UE is capable of being maintained.

Alternatively, the UAM UE may directly transmit the first message. For example, the UAM UE may generate/obtain/configure the slice information through the authentication procedure with the first UE and transmit the first message containing the slice information to the BS. In this case, the UAM UE may further include authentication information on the first UE in the first message. The first UE may request the slice formation procedure with the BS through the transmission of the first message by the UAM UE. Additionally, as mentioned above, the UAM UE may measure the altitude and/or speed thereof through the UAM device or a measurement device and determine the timing of transmitting the first message based on the measured altitude and/or speed.

In this way, the first UE may quickly form the slice corresponding to the UAM service by transmitting the first message containing the slice information configured/generated during the authentication procedure, thereby indicating that the first UE is receiving the UAM service. Additionally, based on the formation of the slice, the first UE may be reconfigured with parameters reconfigured to suit a wireless communication environment for the UAM service.

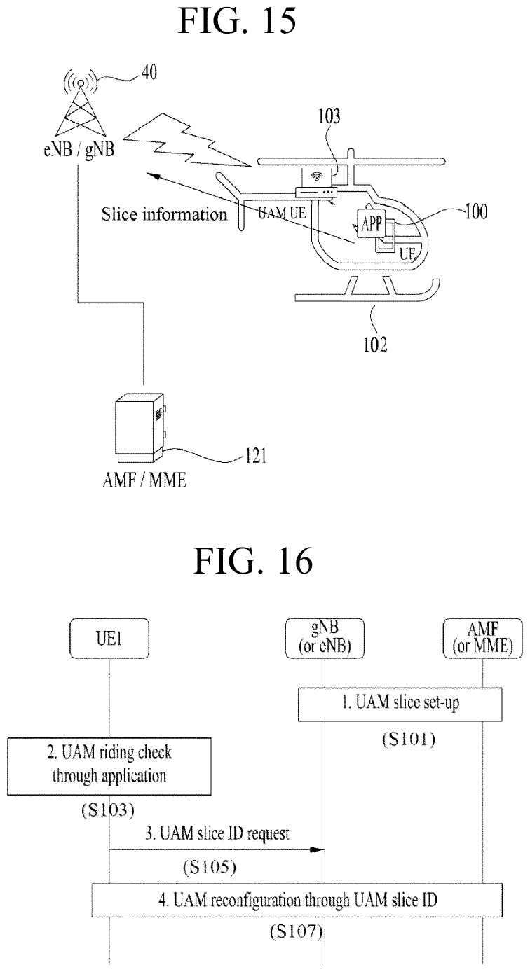

FIG. 18 is a diagram for explaining a method by which a network identifies a first UE receiving a UAM service and forms a slice for the UAM service.

Referring to FIG. 18, the network and a BS may perform a procedure for configuring the slice for the UAM service (S91). In this case, the slice configuration procedure may be carried out through an AMF/MME included in the network.

The network and BS may allocate S-NSSAI for the UAM service by configuring different SD values for each entity providing the UAM service and a (newly) defined SST value for the UAM service.

Alternatively, the network and BS may transmit information on the S-NSSAI allocated for each UAM device or UAM UE providing the UAM service to the UAM device or UAM UE.

Next, the network may identify the first UE related to the UAM service based on slice information related to the UAM service included in a first message (S93). Specifically, the network may receive the first message transmitted by the first UE through the BS. The network may identify the first UE related to the UAM service based on the slice information related to the UAM service included in the first message. Alternatively, based on the S-NSSAI included in the slice information, the network may identify that the first UE that transmits the first message is a UE related to the UAM service and also identify the slice for the UAM service.

Next, the network may form the slice corresponding to the slice information for the identified first UE (S95). The network may form the slice corresponding to the slice information with the first UE (through the BS) from among pieces of S-NSSAI allocated during the configuration procedure.

The configuration of the aforementioned S-NSSAI, the identification of the first UE, and the formation of the slice may be performed through the AMF or MME included in the network.

Referring to FIG. 10, the first device 100 or processor(s) 102 may perform operations related to the embodiments described in FIGS. 14 to 18. Specifically, the first device 100 or processor(s) 102 may control the transceiver to perform authentication for the UAM service with the UAM UE included in the UAM device, generate the slice information related to the UAM service based on the authentication, and transmit the first message containing the slice information to the BS. Alternatively, the first device 100 or processor(s) 102 may generate the information on the S-NSSAI for the UAM service and transmit the information through the first message. In this case, the information on the S-NSSAI may include the SST and SD values allocated for the UAM service.

The network described in FIGS. 14 to 18 includes a communication interface and a processor connected to the communication interface, and the network may exchange information with the BS through the communication interface. The communication interface may be an interface for transmitting and receiving information related to a backhaul link. The network may perform the operations described in FIGS. 14 to 18. For example, the processor may configure the S-NSSAI for the UAM service, identify the first UE related to the UAM service based on the slice information related to the UAM service included in the first message, and form the slice with the first UE based on the slice information.

As explained with reference to FIG. 1, if a UE receiving a UAM service is not equipped with specific functions for the UAM service, the BS may not identify a UE receiving the UAM service or a UE mounted in a UAM device (e.g., air taxi or flying taxi) providing the UAM service. Since the BS and network providing wireless communication services to the UE is incapable of identifying the UE mounted on the device or the UE receiving the UAM service, the BS and network may have difficulty selectively establishing a communication environment suitable for the UAM service for the UE. In this case, establishing the suitable communication environment may be achieved by tilting the antenna of the equipment included in the BS toward the air to improve the radio channel environment or by reconfiguring parameters related to wireless communication to be suitable for the UAM service.

Thus, considering that there are currently no specific functions specialized for the UAM service, it is necessary to consider a method for supporting the network in identifying the UE that is mounted on the device or receiving the UAM service based on information obtained through an application by the server managing and operating the UAM service (UTM server).

Hereinafter, a method by which the network supports the identification of the UE mounted on the device or the UE receiving the UAM service will be described.

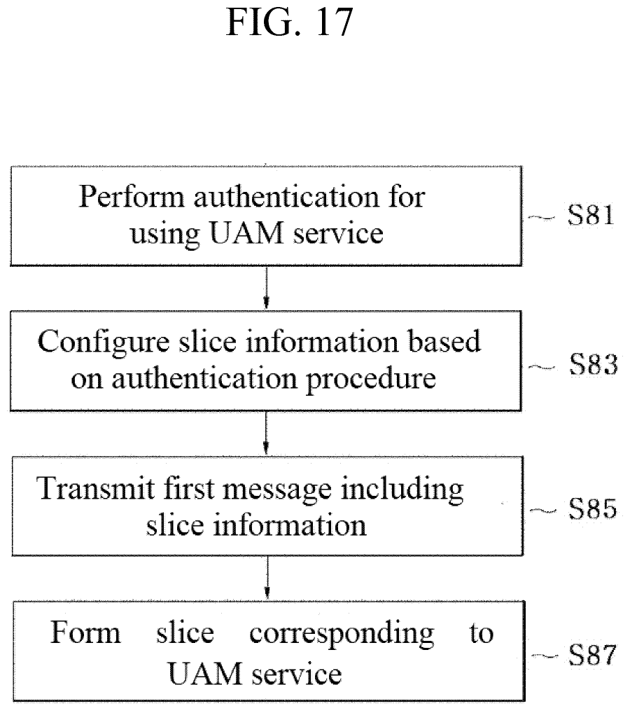

FIG. 19 is a diagram for explaining a method by which a network identifies a UE related to a UAM service.

Referring to FIG. 19, a UAM UE 103 is a UE related to a UAM device (e.g., air taxi or flying taxi) that provides a UAM service. For example, the UAM UE 103 may be a UE attached or mounted on the UAM device or a UE of an operator that controls or operates the UAM device. The UAM UE 103 may communicate with a UTM server 200 through an application related to the UAM service. The UAM UE 103 and the UAM device may correspond to each other in terms of the configuration, but for convenience in explanation, the UAM UE 103 and the UAM device will be distinguished in the following description.

The UAM UE 103 may recognize or identify a UE 100 mounted on the UAM device to receive the UAM service. The UAM UE 103 may perform an authentication procedure with the UE 100 mounted on the UAM device through an application related to the UAM service. Through the authentication procedure, the UAM UE 103 may obtain authentication information related to the UE 100. In this case, the UAM UE 103 may transfer or transmit the obtained authentication information to the UTM server 200 via the BS 40.

The UTM server 200 may transmit a first message generated based on the authentication information to enable a network (or core network (CN)) 120 to identify the UE 100 related to the UAM service. In this case, the network 120 may identify the UE related to the UAM service among UEs using wireless communication through the first message transmitted by the UTM server 200. The network 120 may control the BS 40 to reconfigure at least one parameter for the UE 100 to provide a suitable communication environment for the UAM service to the UE 100.

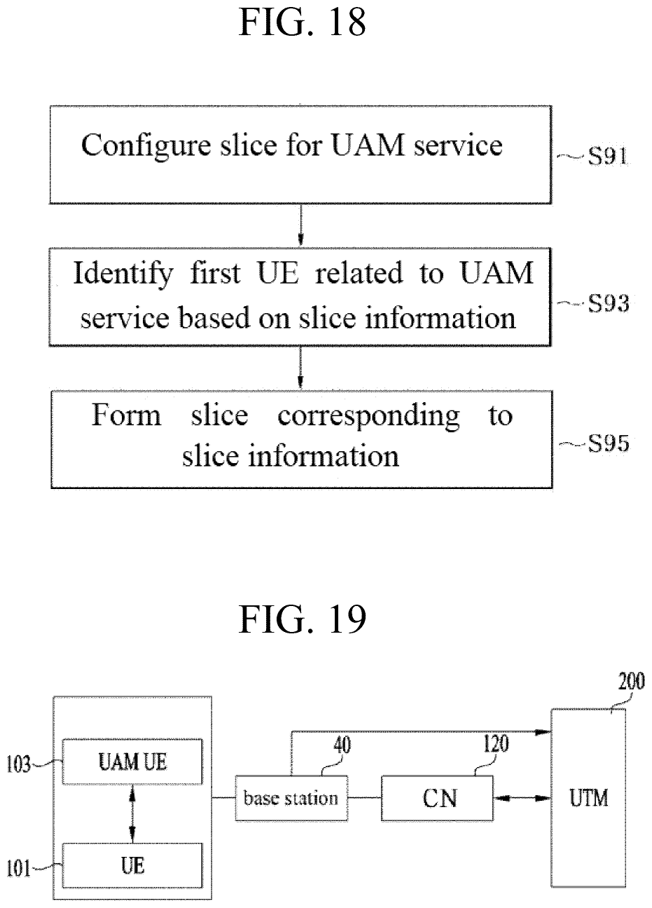

FIG. 20 is a diagram for explaining a method by which a UTM server provides information on a UE receiving a UAM service to a network.

Referring to FIG. 20, as described above, a UAM UE 103 may recognize or authenticate a UE 100 that intends to receive the UAM service or is mounted on a UAM device. For example, the UAM UE 103 may perform authentication for the UE 100 mounted on the UAM device using an authentication procedure through an application related to the UAM service. Alternatively, the UAM UE 103 may perform the authentication procedure with the UE 100 through the application using proximity communication such as NFC or Bluetooth. Alternatively, the UAM UE 103 may perform the authentication procedure with the UE 100 through the application using tethering or a hotspot based on WiFi or Bluetooth. Alternatively, the UAM UE 103 may establish a sidelink (or D2D communication) with the UE 100 based on LTE or 5G communication and perform the authentication procedure through the application via the sidelink. The UAM UE 103 may also perform the authentication procedure with the UE 100 through the application using other forms of communication methods besides the ones described. The method of performing the authentication procedure through the application is not limited to the examples mentioned above.

The UAM UE 103 may obtain authentication information on the UE 100 through the application authentication procedure. The authentication information may include UE identification information on the UE 100 and/or user identification information on the user of the UE 100. For example, the UE identification information may include information on the UE ID, IMSI, IMEI, operator, and phone number of the UE 100. The user identification information may include information on the resident registration number, name, address, and credit card of the user.

The UAM UE 103 may transmit the obtained authentication information to a UTM server/AF 200 via the BS 40. The UTM server/AF 200 may transmit a first message containing information for identifying the UE related to the UAM service to the network based on the authentication information. For example, the UTM server/AF 200 may transmit or forward the first message containing the information for identifying the UE related to the UAM service to an NEF 129 included in the network. The UTM server/AF 200 may be defined as a UTM server and/or an external AF, but for the sake of convenience of the explanation, the UTM server/AF 200 will be referred to as the UTM server 200.

The NEF 129 may provide the identification information on the UE 100 and information on the UAM service to an AMF/MME 121 included in the network based on the first message. The AMF/MME 121 may recognize or identify that the UE 100 is related to the UAM service based on the identification information on the UE 100 and the UAM service information. Alternatively, the AMF/MME 121 may forward the identification information on the UE 100 and the UAM service information to the BS 40 and instruct the BS 40 to reconfigure at least one parameter for the UE 100.

The BS 40 may reconfigure the at least one parameter for the UE 100 based on the identification information on the UE 100 and the UAM service information to establish a wireless communication environment suitable for the UAM service. For example, the BS may reconfigure the at least one parameter such that the value of TTT or the range of a TA increases, thereby preventing frequent handovers. Alternatively, the BS may reconfigure the at least one parameter such that communication via the sidelink with the UAM UE 103 is continued. Alternatively, the BS 40 may adjust an antenna direction and/or beamforming direction in response to changes in the location of the UE 100 that receives the UAM service

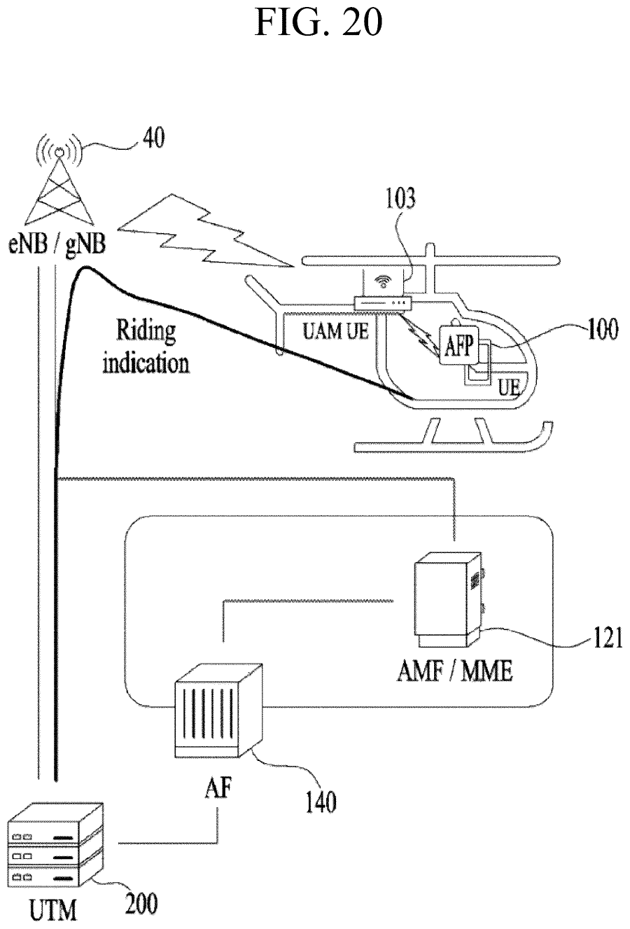

FIG. 21 is a diagram for explaining a method by which a UTM server, network, and UAM UE support a UAM service.

### (1) Authentication Procedure Related to Mounting of UAM UE and UE

Referring to FIG. 21, the UAM UE may perform an authentication procedure with a first UE, which is mounted on a UAM device, through an application (S101). As mentioned above, the authentication procedure through the application may be carried out using proximity communication (NFC, Bluetooth, etc.), WiFi tethering, sidelink, or other similar methods between the first UE and the UAM UE. Through the authentication procedure, the UAM UE may obtain authentication information including identification information on the UE and/or the user thereof.

The UAM UE may transmit the authentication information to a BS (S102). As mentioned above, the authentication information may include information on the UE ID, IMSI, IMEI, operator, and phone number of the UE as well as information on the resident registration number, address, name, and credit card of the user. Alternatively, the authentication information may further include indication information indicating the mounting of the UE. Alternatively, the authentication information may also include identification information on the UAM UE (UE ID, IMSI, IMEI, operator, and phone number).

The BS may forward the received authentication information to the UTM server (or external AF) (S103). For example, the authentication information may be transmitted to the UTM server or external AF via the BS and a 5G system. As mentioned above, the UTM server is a server that manages and oversees the operation of an unmanned aerial system (UAM) and/or UAM devices. The UTM server may perform management operations related to the mounting of the first UE and the provision of the UAM service. Alternatively, the management operations related to the mounting of the first UE may be performed by a server configured separately from the UTM server.

### (2) Procedure for Configuration and Transmission of Request Message

Next, upon receiving the authentication information, the (external) AF or UTM server may configure or generate a request message to be transmitted to the network (5G system (5GS)) based on the UE ID and UAM information obtained from the authentication information.

First, the (external) AF or UTM server may identify and/or specify the network and a NEF (or NEF address) that provide wireless communication services to the UE through information on information on the operator, phone number, etc., included in the authentication information.

The (external) AF or UTM server may transmit a request message containing the UE identification information and the indication information indicating the mounting of the first UE, which are obtained from the authentication information, to the identified NEF (S104). For example, the (external) AF or UTM server may transmit or forward to the NEF a message including information for identifying the first UE such as the UE ID, IMSI, phone number, user's name, user's resident registration number, or user's address, as well as the indication information indicating the mounting of the first UE. Alternatively, the (external) AF or UTM server may further transmit information related to the operation of the UAM device and/or information on a QCI, SPID, or Slice ID (S-NSSAI) assigned or pre-configured for the UAM service.

The message used by the (external) AF or UTM server to transmit updated information based on the existing Nnef service to the NEF may not be suitable for use as the request message for requesting updates per UE because the message used by the (external) AF or UTM server is a type of message for requesting updates per service. Thus, a new message type for requesting updates per UE or requesting UE-specific updates needs to be defined. For example, the request message may be a new type of message that allows to request service information per UE. That is, the request message may be a message of the type Nnef_UEParameter_Update_Request, which requests service updates from the NEF. In this case, the (external) AF or UTM server may request a service update for a specific UE, such as the first UE, from the NEF through a request message of the newly defined type Nnef_UEParameter_Update_Request.

### (3) Service Update Procedure Based on Request Message

The NEF may perform an update of the service information (or UAM information) for the first UE in a UDR included in the network based on the request message. If the NEF successfully completes the update of the service information for the UE in the UDR, the NEF may transmit to the (external) AF or UTM server a response message indicating that the update of the service information for the first UE was successfully completed (S105). In this case, the response message may include the UE ID of the first UE and/or information on an acknowledgement (ACK). In addition, the response message is a response message regarding the completion of a UE-specific or per-UE update, rather than a service-based update. Therefore, the response message may also be newly defined. For example, the response message may be transmitted to the (external) AF or UTM server based on the new message type, Nnef_UEParameter_Update_Response.

Alternatively, the NEF and/or UDR (or a PCF) may determine or obtain UAM service information corresponding to the indication information (indication the mounting of the UAM device) and the authentication information (or information on the first UE) included in a first message. For example, if the instruction information is included in the first message, the NEF and/or UDR may determine or obtain a specific QCI value pre-assigned for the UAM service, a specific SPID value assigned for the UAM service, and/or a specific slice ID (S-NSSAI) value assigned for the UAM service as the UAM service information. Alternatively, the NEF and/or UDR may determine or obtain the QCI, SPID, and/or S-NSSAI values assigned in response to the instruction information and/or the UAM service-related information (UAM operation information, identification information on the UAM UE, etc.) included in the first message as the UAM service information. Alternatively, the UAM service information may be directly provided through the request message from the UTM server.

Next, the NEF/UDR may transmit a message containing service information updated for the first UE to the PCF included in the network (S106). Alternatively, the NEF/UDR may transmit the message to the PCF by further including the UAM service information and/or the UE ID. In this case, the PCF may establish policies related to the UAM service based on the message. For example, the NEF/UDR may transmit a message of the type Nudr_DM_notify containing the updated service information and/or the UAM service information to the PCF to request the establishment of a new policy for the first UE.

Next, in response to the establishment of the new policy, the PCF may transmit a message containing at least one of policy provisioning information, the UE ID, or the UAM service information to an AMF or MME to identify that the first UE is related to the UAM service (S107). The message may be a message of the type Namf_Communication_N1N2MessageTransfer, which is used by the PCF to provide information related to the establishment of the new policy. As described above, the UAM service information may include the specific QCI value assigned for the UAM service, specific SPID value assigned for the UAM service, and/or specific S-NSSAI value assigned for the UAM service. In this case, based on the UAM service information, the AMF or MME may recognize or identify that the first UE corresponding to the UE ID is a UE related to the UAM service.

Next, the AMF or MME may transmit a message containing the UE ID and/or the UAM service information to the BS (gNB or eNB) (S108). The message may include the specific QCI value, specific SPID value, and/or specific S-NSSAI value assigned for the UAM service.

The BS may reconfigure at least one parameter for the first UE based on the message received from the AMF or MME. The message may be based on at least one of the message types capable of being exchanged between the AMF or MME and the BS, such as a message related to the establishment of a PDU session.

For example, the BS may increase a TTT value for the first UE to prevent the first UE from frequently performing handovers. Alternatively, the BS may reconfigure a TA for the UE to be broader than the TA for UEs on the ground. Alternatively, the BS may reconfigure related parameters to allow the UE to perform wireless communication through a sidelink formed with the UAM UE. Alternatively, the BS may form a slice with the first UE based on the specific QCI value, specific SPID value, and/or specific S-NSSAI value. Through the formation of this slice, the BS may reconfigure parameters such as the TTT and TA.

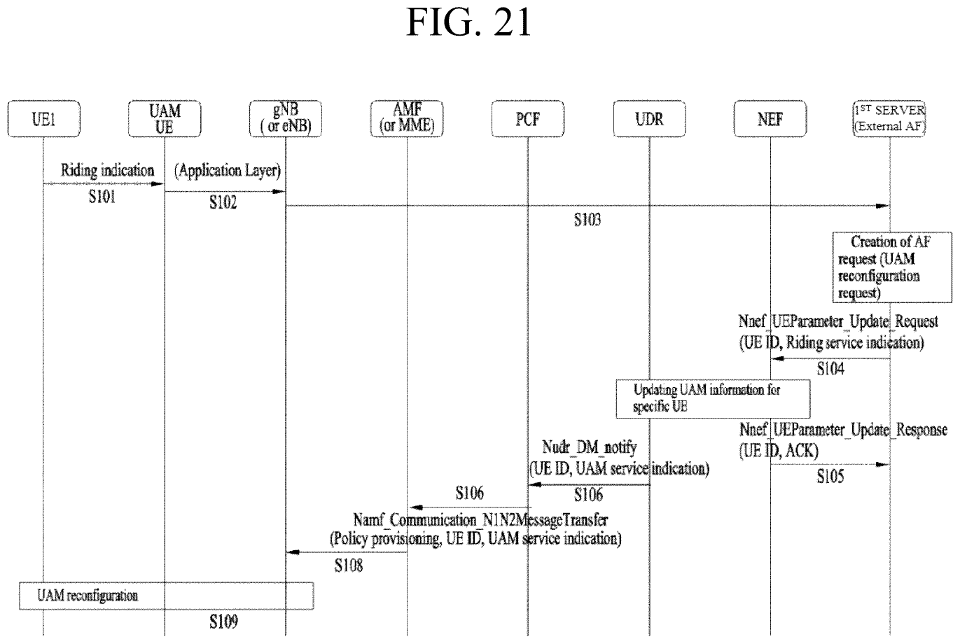

FIG. 22 is a flowchart for explaining a method by which a UTM server transmits a request message to a network to identify a first UE related to a UAM service.

Referring to FIG. 22, the UTM server, which is a first server, may receive authentication information transmitted from a UAM UE through a BS (S221). As described in FIGS. 19 to 21, the authentication information may include identification information on the first UE mounted on a UAM device (e.g., flying taxi) where the UAM UE is mounted or equipped and/or the UAM UE. Alternatively, the UTM server may receive the authentication information from the UAM UE through an application layer.

Next, the UTM server may configure and/or generate a request message based on the authentication information and transmit the request message to the network (or a NEF included in the network) (S223). As described in FIGS. 19 to 21, the request message is a message requesting an update of service information for the first UE mounted on the UAM device. The request message may include information that allows the network to identify the first UE. As described above, the request message may be a newly defined message that allows to request to update service information per UE. In addition, the request message may be to trigger the network to perform the following operations: identifying the first UE related to the UAM service and supporting the UAM service for the first UE.

Next, the UTM server may receive a response message from the network (or the NEF included in the network) in response to the request message (S225).

In this way, the UTM server may receive the authentication information from the UAM UE and transmit the newly defined type of request message to the network to request updates per UE based on the received authentication information. In this case, by transmitting the request message, the UTM server may request the network to update the service information for the first UE and instruct the network to recognize that the first UE is related to the UAM service. Thus, the UTM server may allow the network to identify that the first UE is a UE related to the UAM service via the request message and may also support the UE and the network in selectively establishing a communication environment suitable for the UAM service for the first UE.

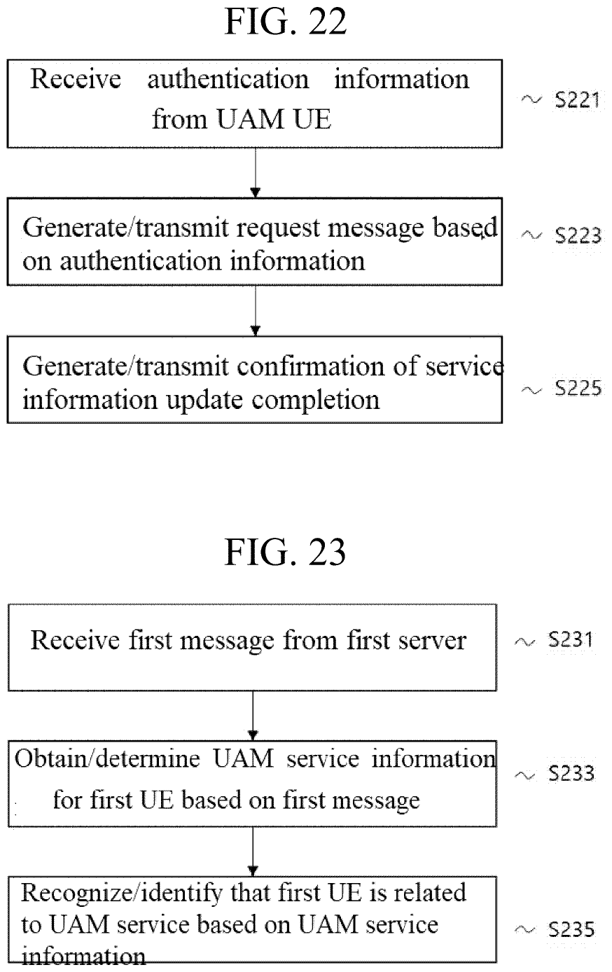

FIG. 23 is a flowchart for explaining a method by which a network identifies and supports a first UE related to the UAM service.

Referring to FIG. 23, the network may receive a first message from a UTM server, which is the first server (S231). In this case, the first message may include a UE ID and/or indication information indicating mounting of the UE, based on authentication information obtained by the UTM server. In addition, the first message may be a newly defined message intended to request a service update per UE, rather than a conventional update request per service. For example, the first message may be a newly defined message of the type nef_UEParameter_Update_Request.

Next, the network may determine or obtain UAM service information corresponding to the first UE based on the first message (S233). As described above, the network may determine or obtain the UAM service information corresponding to the first UE and/or the indication information included in the first message. For example, the network may determine and/or obtain the UAM service information, which includes a QCI, SPID, or slice ID (S-NSSAI) assigned for the UAM service, corresponding to the first UE and/or the indication information included in the first message.

The network may identify or recognize that the first UE, which is related to the service information update in the first message, is related to the UAM service based on the UE ID and/or the UAM service information for the first UE (S235). In this case, the network may transmit a message containing the UAM service information and/or the UE ID to a BS to ensure that a communication environment suitable for the UAM service is established for the first UE. Upon receiving the message from the network, the BS may reconfigure a TTT value to be larger to prevent the first UE from performing frequent handovers. Alternatively, the BS may reconfigure parameters to enable the first UE to form a sidelink with the UAM UE and continue wireless communication through the UAM UE. Alternatively, the BS may reconfigure a TA for the first UE to be broader than that of UEs performing communication on the ground.

Alternatively, the BS may form a slice corresponding to the QCI, SPID, or slice ID (S-NSSAI) included in the message with the first UE. Herein, a slice refers to a virtualization layer applied to wireless network services where multiple logical networks are configured within a single physical network. As a cloud or container server is not merely a physical server but a virtualized entity, in a network, independent logical networks may be created within a large physical network based on automated bandwidth allocation, QoS rules, and other network functions. For example, software-defined networking (SDN) and network function virtualization technologies, integrated with automation, may be used to dynamically manage multiple slices on a large network. Similarly to other networks, network slices include the same control plane, user plane, and access network interface, and the network slice may be partially divided when multiple virtual networks need to be supported. In this way, a single network may be logically divided into multiple networks, each of which may be provided with the capacity and functionality suitable for each purpose.

In other words, the ID corresponding to the slice related to the UAM service may be pre-configured among the BS, the network, and/or the UTM server. The BS may then form the slice corresponding to the QCI, SPID, or slice ID with the first UE.

As explained with reference to FIG. 2, the network may include functional components such as a NEF, PCF, UDR, and AMF (or MME). When the network identifies the first UE based on the first message, the message flow among the functional components within the network may be carried out as described in FIG. 21.

For example, the NEF included in the network may receive the first message containing the UE ID and indication information indicating the mounting of the first UE from the first server. In this case, the NEF may update the service information for the first UE in the UDR based on the first message. If the update of the UDR for the first UE is successfully completed, the NEF may transmit a response message to the first server (or UTM server). The UDR/NEF may transmit a message (e.g., a message of the type Nudr_DM_notify) to the PCF, which includes the updated service information and/or the UAM service information corresponding to the first message. Based on the message, the PCF may establish a new policy and transmit a message (e.g., of the type a message Namf_Communication_N1N2MessageTransfer) containing the UAM service information and the UE ID to the AMF/MME. Based on the message transmitted by the PCF, the AMF/MME may identify or recognize that the first UE corresponding to the UE ID is related to the UAM service. The AMF/MME may transmit the UAM service information (and/or the UE ID) to the BS to ensure that a communication environment suitable for the UAM service is established for the first UE. The BS may then reconfigure at least one parameter for the first UE based on the received UAM service information (and/or the UE ID).

In this way, the network may effectively identify or recognize the first UE, which is a UE receiving the UAM service, based on the UE-specific first message received from the UTM server. The network may provide the BS with information on the identified first UE to ensure that the at least one parameter for the identified first UE is reconfigured, thereby selectively providing and establishing the communication environment suitable for the UAM service by providing the BS with information on the identified first UE.

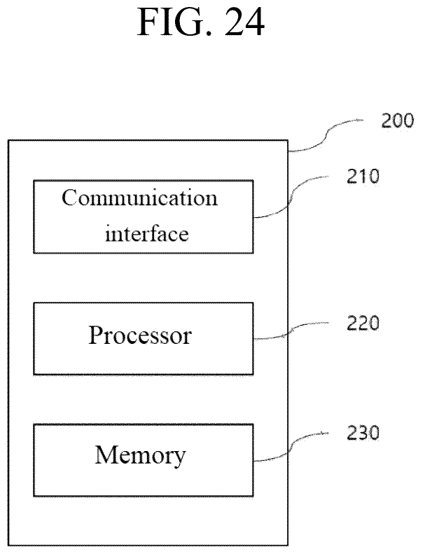

FIG. 24 is a diagram for explaining a first server that supports a UAM service.

A first server 200 may include a communication interface 210, one or more processors 220, and one or more memories 230. The processor(s) 220 may be configured to control the memory(s) 230 and/or the communication interface 210 to implement the descriptions, functions, procedures, proposals, methods, and/or operation flowcharts disclosed in this document. In this case, the communication interface 210 may transmit or receive information through a backhaul link formed with the above-described network. For example, the processor(s) 220 may process information in the memory(s) 230 to generate first information and then transmit or transfer a message containing the first information via the communication interface 210. In addition, the processor(s) 220 may receive a message containing second information/signals through the communication interface 210 and then store the second information in the memory(s) 230. The memory(s) 230 may be connected to the processor(s) 220 and may store various information related to the operation of the processor(s) 220. For example, the memory(s) 230 may store software code including instructions for performing a part or the entirety of processes controlled by the processor(s) 202 or for performing the descriptions, functions, procedures, proposals, methods, and/or operational flowcharts disclosed in this document. Herein, the processor(s) 220 and the memory(s) 230 may be part of a communication modem/circuit/chipset designed to implement wireless communication technologies (e.g., LTE, NR, etc.).

For example, the first server 200 may be an external AF or UTM server that supports the UAM service. The first server 200 or processor(s) 220 may perform the operations related to the embodiments described in FIG. 2, FIG. 3, FIG. 13, and FIGS. 19 to 23.

Specifically, the first server 200 or processor(s) 220 may control the communication interface 210 to receive authentication information on a first UE related to the UAM service from a UAM device and transmit a request message to an NEF based on the authentication information. In this case, the request message may be defined as a message for requesting the update of service information per UE. Alternatively, the authentication information may be received when the first UE is mounted on the UAM device. The authentication information may also include at least one of identification information on the first UE, operator information, and unique information on the user of the UE. Alternatively, the processor(s) 220 may identify the NEF related to the first UE based on the authentication information. The request message may include the identification information on the first UE and indication information indicating that the first UE is mounted on the UAM device related to the UAM service. The processor(s) 220 may also control the communication interface 210 to receive from the NEF a response message containing information on the completion of the service information update for the first UE. Alternatively, the request message may be a message of the type nef_UEParameter_Update_Request.

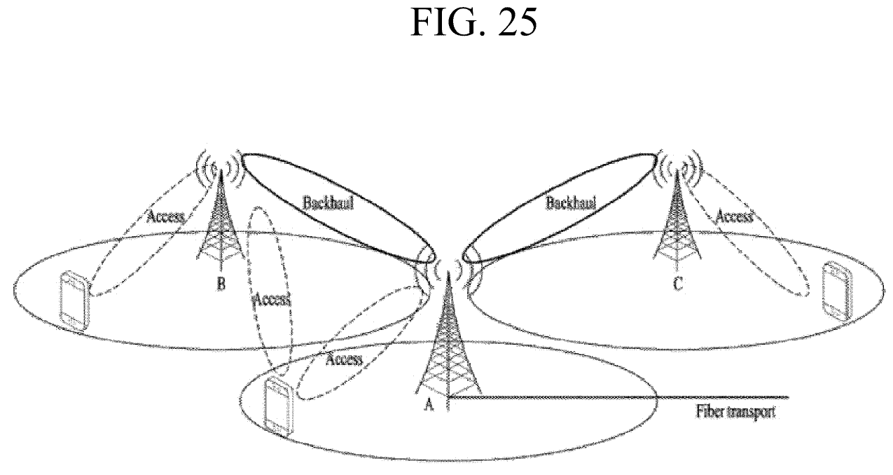

FIG. 25 is a diagram schematically illustrating an example of an integrated access and backhaul link.

FIG. 25 shows an example of a network with the integrated access and backhaul link (IAB), where an IAB node or relay node (relay transmission/reception point (rTRP)) may multiplex access and backhaul links in time, frequency, or space (e.g., beam-based operation).

The operation on different links may occur on the same or different frequencies (which may also be referred to as “in-band” and “out-of-band” relays). While efficient support for out-of-band relays is important in some NR deployment scenarios, it is crucial to understand the requirements for in-band operation, which involves tight interaction with access links operating on the same frequency to accommodate duplex constraints and prevent/mitigate interference.

In addition, operating NR systems in a millimeter wave (mmWave) spectrum may have some unique challenges including experiencing severe short-term blocking, which may not be easily mitigated by the current RRC-based handover mechanism, due to the larger time scale required to complete procedures compared to short-term blocking.

To overcome the short-term blocking in the mmWave system, a fast RAN-based mechanism for switching between rTRPs may be required (which does not necessarily involve the intervention of the core network).

The need to facilitate the deployment of self-backhauled NR cells and to mitigate the short-term blocking in NR operations within the mmWave spectrum may drive the development of an integrated framework that enables rapid switching between access and backhaul links.

In addition, over-the-air (OTA) coordination between rTRPs may be considered as a means to mitigate interference and support end-to-end route selection and optimization.

The following requirements and aspects may need to be addressed by an IAB for NR.
Efficient and flexible operation for in-band and out-of-band relays in indoor and outdoor scenarios
Multi-hop and redundant connectivity
End-to-end route selection and optimization
Support for backhaul link with high spectral efficiency
Support for legacy NR UE

Legacy NR (new radio access technology (RAT)) is designed to support half-duplex devices. In addition, supporting half-duplex in IAB scenarios is valuable and worth considering. Furthermore, full-duplex IAB devices may also be explored.

In IAB scenarios, if each IAB node or relay node (RN) does not have scheduling capabilities, a donor gNB (DgNB) needs to schedule all links between the DgNB, associated RNs, and UEs. In other words, the DgNB needs to gather traffic information from all the associated RNs, make scheduling decisions for all the links, and then provide the scheduling information to each RN.

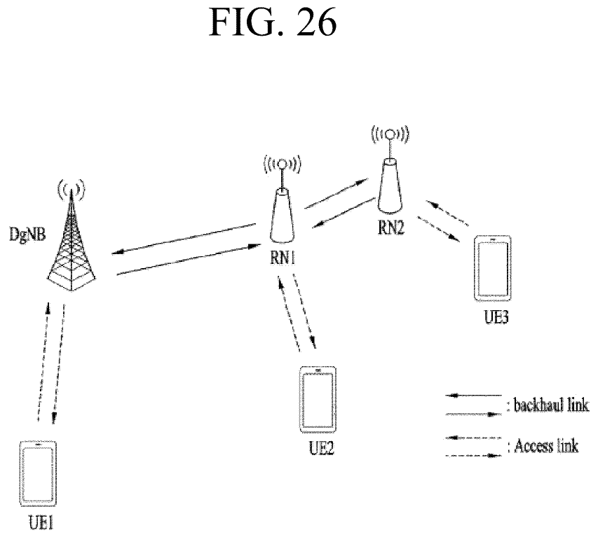

FIG. 26 is a schematic diagram illustrating an example of links between a DgNB, an RN, and a UE.

Referring to FIG. 26, for example, the link between the DgNB and UE1 may be an access link, and the link between RN1 and UE2 and the link between RN2 and UE3 may also be access links.

Similarly, referring to FIG. 26, for example, the link between the DgNB and RN1 and the link between RN1 and RN2 may be backhaul links.

For example, backhaul and access links may be configured as illustrated in FIG. 26. In this case, the DgNB may receive scheduling requests not only from UE1 but also from UE2 and UE3. Subsequently, the DgNB may make scheduling decisions for the two backhaul links and the three access links and then notify the scheduling results. Therefore, the centralized scheduling approach involves delay scheduling and latency issues.

On the other hand, distributed scheduling may be achieved if each RN has scheduling capabilities. The distributed scheduling allows for immediate scheduling in response to an uplink scheduling request from a UE, and backhaul/access links may be used more flexibly by considering the surrounding traffic conditions.

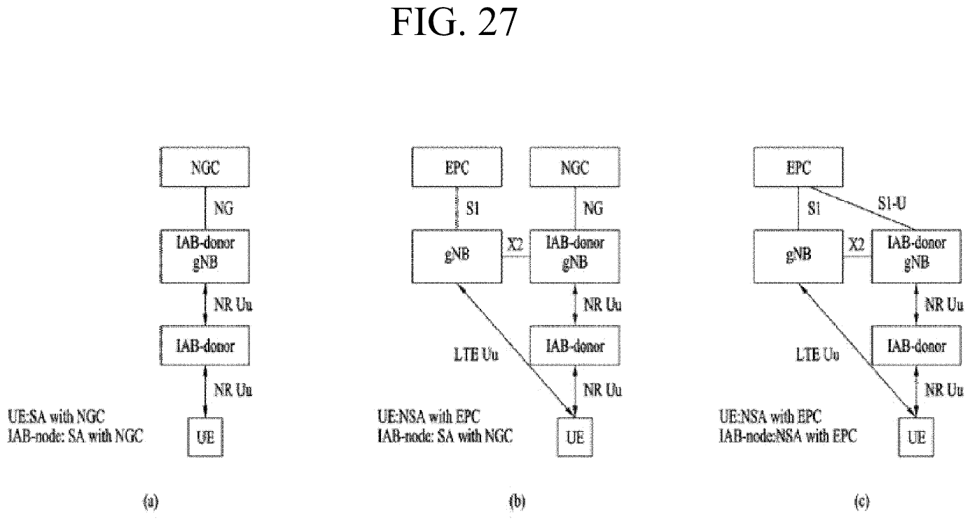

FIG. 27 is a diagram illustrating operations of an IAB node in a Stand-Alone (SA) mode and a Non-Stand-Alone (NSA) mode.

The IAB node may operate in the SA or NSA mode. When the IAB node operates in the NSA mode, only a NR link may be used for backhauling. A UE connected to the IAB node may select a different operating mode from that of the IAB node. In other words, the UE may connect to a different type of CN in addition to the connected IAB node. In this case, the UE may use a (enhanced) dedicated core network ((e)DECOR) or slicing for CN selection. IAB nodes operating in the NSA mode may be connected to the same eNB or to different eNBs.

Additionally, UEs operating in the NSA mode may be connected to the same eNB as that of an IAB node which the UEs are connected to, or the UEs may be connected to different eNBs. FIG. 27 illustrates an example of an SA mode with an NGC and an NSA mode with an evolved packet core (EPC).

Specifically, FIG. 27(a) illustrates an example of a UE and an IAB node operating in the SA mode connected to the NGC. FIG. 27(b) illustrates an example where an IAB node is connected to the NGC and operates in the SA mode and a UE is connected to the EPC and operates in the NSA mode. Additionally, FIG. 27(c) illustrates an example where a UE and an IAB node are connected to the EPC and operate in the NSA mode.

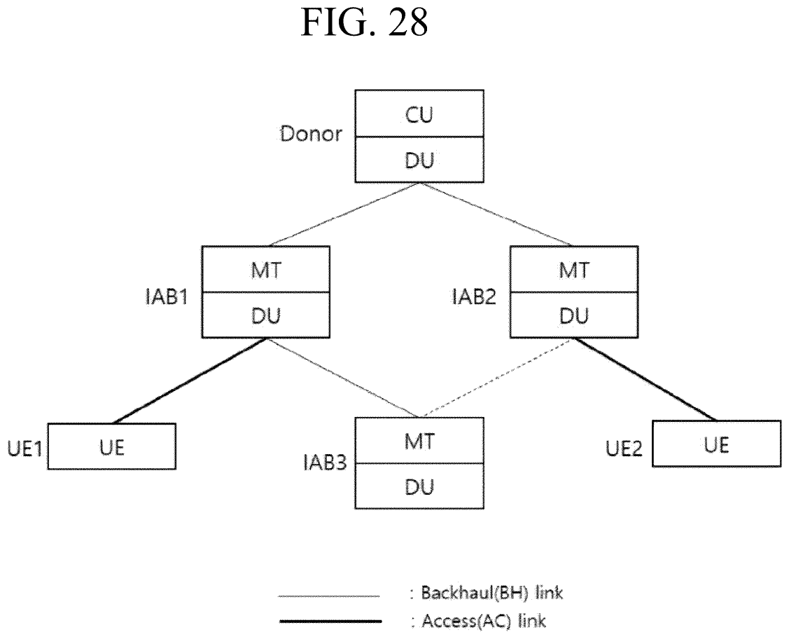

FIG. 28 schematically illustrates an example of backhaul and access links.

As shown in FIG. 28, the link between a donor node and an IAB node or the link between IAB nodes is called the backhaul link. In contrast, the link between a donor node and a UE or the link between an IAB node and a UE is called the access link. In other words, the link between a mobile termination (MT) and a parent distributed unit (DU) or the link between a DU and a child MT is called the backhaul link, while the link between a DU and a UE is called the access link.

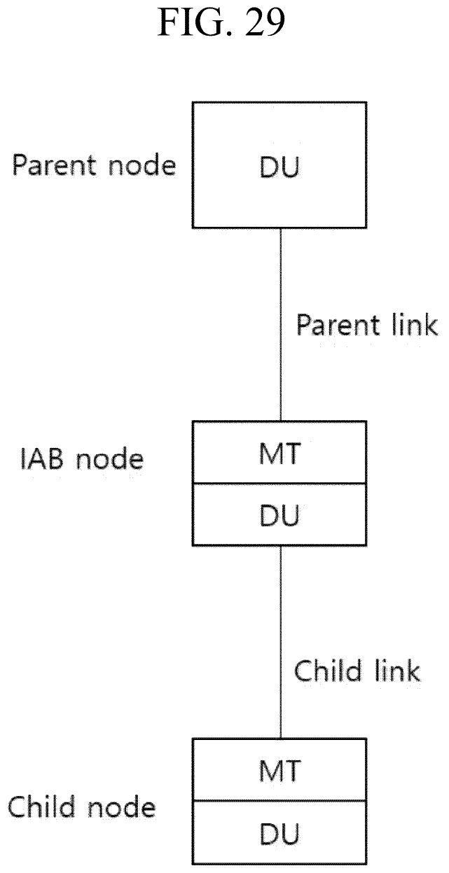

FIG. 29 schematically illustrates an example of parent and child links.

As shown in FIG. 29, the link between an IAB node and a parent node is called a parent link, while the link between the IAB node and a child node/UE is called a child link. In other words, the link between an MT and a parent DU is called the parent link, and the link between a DU and a child MT/UE is called the child link.

However, depending on the interpretation or perspective, the link between the IAB node and the parent node may be referred to as the backhaul link, while the link between the IAB node and the child node/UE may be referred to as the access link.

The IAB node may be configured with a slot format configuration for communication with the parent node and a slot format configuration for communication with the child node/access UE.

As described above, the IAB node consists of the MT and the DU. The resource configuration for communication between the MT and parent node(s) is referred to as an MT configuration, while the resource configuration for communication between the DU and child node(s) and access UE(s) is referred to as a DU configuration.

More specifically, in the MT configuration, the IAB node may provide information on the link of the parent link between the IAB node and the parent node for communication with the parent node. In the DU configuration, the IAB node may provide information on the link direction and link availability of the child link between the IAB node and the child node/access UE for communication with the child node/access UE.

The terms used in this specification may be as follows.
IAB node (IAB-node): A RAN node that supports wireless access for UE(s) and facilitates wireless backhauling for access traffic.
IAB donor (IAB-donor): A RAN node that provides a core network with UE interfaces and wireless backhaul functionality to IAB node(s).

Hereinafter, each abbreviation may correspond to the following terms:
IAB: Integrated Access and Backhaul
CSI-RS: Channel State Information Reference Signal
DgNB: Donor gNB
AC: Access
BH: Backhaul
DU: Distributed Unit
MT: Mobile Terminal
CU: Centralized Unit
IAB-MT: IAB Mobile Terminal
NGC: Next-Generation Core Network
SA: Stand-Alone
NSA: Non-Stand-Alone
EPC: Evolved Packet Core

From the perspective of an IAB node MT, the following types of time-domain resources may be designated for a parent link:
Downlink time resource;
Uplink time resource; and
Flexible time resource.

From the perspective of an IAB node DU, a child link may have the following types of time-domain resources:
Downlink time resource;
Uplink time resource;
Flexible time resource; and
Unavailable time resources (resource(s) not used for communication on DU child link(s)).

The downlink, uplink, and flexible types of time resources of a DU child link may fall into one of the following two categories.
Hard: A time resource is always available for the DU child link.
Soft: The availability of a time resource for the DU child link may be explicitly and/or implicitly controlled by the parent node.

From the perspective of an IAB node DU, a child link has four types of time resources: downlink (DL), uplink (UL), flexible (F), and not available (NA). Here, an NA resources may mean that the resource is not used for communication on DU child link(s).

The downlink, uplink, and flexible time resources of a DU child link may each be either hard or soft resources. As described above, a hard resource may indicate that communication is always possible on the DU child link. However, in the case of soft resources, the availability of communication on the DU child link may be explicitly and/or implicitly controlled by the parent node.

The configuration of the link direction (DL/UL/F) of a time resource and link availability (hard/soft/NA) for the DU child link may be referred to as a DU configuration.

Such a configuration may be used for effective multiplexing and interference management between IAB nodes. For example, the configuration may be used to indicate which link is valid for time resources between parent and child links.

In addition, configuring only a subset of child node(s) may be used to manage interference between the child node(s) because time resources for DU operations are available.

Considering this aspect, the DU configuration may be more effective when the DU configuration is semi-static and specifically configured for each IAB node.

Similar to a slot format indicator (SFI) configuration for an access link, an IAB node MT may have three types of time resources for the parent link: downlink (DL), uplink (UL), and flexible (F).

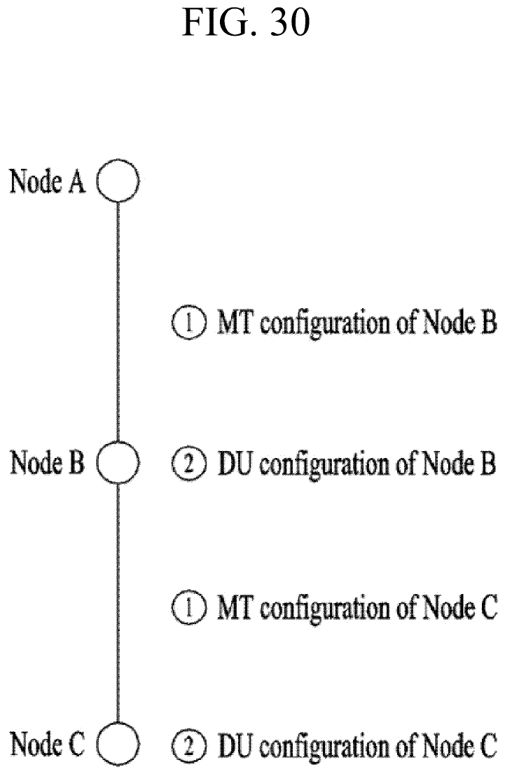

FIG. 30 schematically illustrates a configuration between nodes.

As shown in of FIG. 30, an IAB node receives an MT configuration that provides information on the link direction of a parent link between the IAB node and a parent node to enable communication with the parent node. Additionally, as shown in of FIG. 30, the IAB node receives a DU configuration that provides information on the link direction and link availability for communication on the child link thereof.

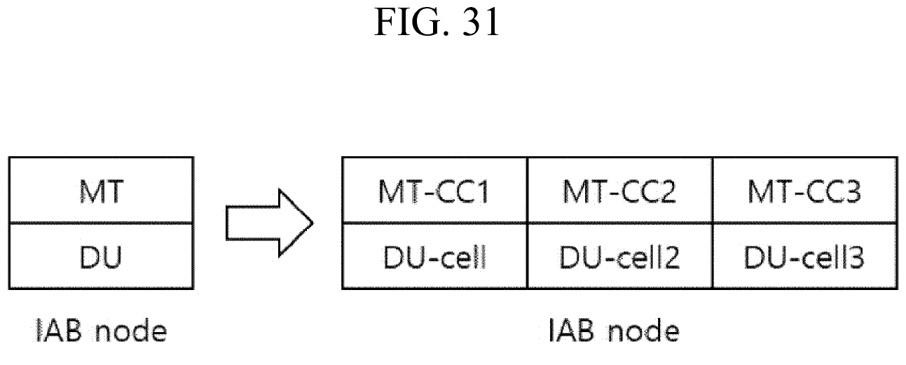

FIG. 31 schematically illustrates an example where an MT and DU of an IAB node are configured with a plurality of component carriers (CCs).

Referring to FIG. 31, the MT and DU of the IAB node may be configured the plurality of CCs. In this case, different CCs may operate in the same or different frequency bands or may use the same or different panels. For example, the MT and DU within the IAB node may each have three CCs. In FIG. 31, the three CCs in the MT are referred to as MT-CC1, MT-CC2, and MT-CC3. For the DU, the CCs are replaced by cells, and the cells are referred to as DU-cell1, DU-cell2, and DU-cell3.

In this case, one of the following multiplexing methods: time division multiplexing (TDM), space division multiplexing/frequency division multiplexing (SDM/FDM), or frequency division (FD) may be applied between a specific CC of the MT and a specific cell of the DU. For example, if a specific MT-CC and DU-cell are located in different inter-band frequency regions, FD may be applied between the MT-CC and DU-cell. On the other hand, if the MT-CC and DU-cell are located in the same frequency region, the TDM may be applied between the MT-CC and DU-cell. In FIG. 14, MT-CC1, MT-CC2, DU-cell1, and DU-cell2 have a center frequency of f1, while MT-CC3 and DU-cell3 have a center frequency of f2, where f1 and f2 may be located within different inter-bands. In this case, from the perspective of MT-CC1 (or MT-CC2), MT-CC1 operates with DU-cell1 and DU-cell2 based on TDM but operates with DU-cell3 based on FD. On the other hand, from the perspective of MT-CC3, MT-CC3 operates with DU-cell1 and DU-cell2 based on FD but operates with DU-cell3 based on TDM.

Different multiplexing methods may be applied to the MT and DU within the same CC. For example, there may be a plurality of parts within an MT-CC and/or a DU-cell. These parts may refer to links transmitted by antennas with the same center frequency but different physical locations or by different panels.

Alternatively, for example, the parts may refer to links that have the same center frequency but are transmitted in different bandwidth parts (BWPs). In such cases, for example, when two parts exist within DU-cell1, the multiplexing type applied to a specific MT-CC or a specific part within the MT-CC may vary for each part. While the present disclosure will be described based on cases where the multiplexing type vary for each pair of the CC of an MT and the cell of a DU, the present disclosure may also be extended and applied to cases where an MT and a DU are each consists of a plurality of parts and the multiplexing type may vary for each pair of the CC of the MT and the cell of the DU

It may be considered that a single IAB node is connected to two or multiple parent nodes. In this case, an IAB MT may be connected to two parent DUs based on a dual-connectivity approach.

An IAB node may have redundant route(s) to an IAB donor CU. For IAB node(s) operating in the SA mode, NR dual-connectivity (DC) may be used to enable the IAB-MT to have BH RLC channel(s) with the two parent nodes simultaneously, thereby activating path redundancy in a BH.

For the two parent nodes, it may need to be connected to the same IAB donor centralized unit control plane (CU-CP) that controls the establishment and release of redundant routes through the two parent nodes.

The parent node may assume the roles of a master node and a secondary node for the IAB-MT. together with the IAB donor CU. A NR DC framework (e.g., master cell group/secondary cell group-related (MCG/SCG-related) procedures) may be used to establish a dual radio link with the parent nodes.

### Initial Access at IAB Node

The IAB node may initially follow the same initial access procedure as the UE to establish a connection with a parent IAB node or an IAB donor. Synchronization signal block/channel state information reference signal (SSB/CSI-RS) based RRM measurement, which is defined in Rel-15 NR, may serve as a starting point for a discovery and measurement method of the IAB node.

For example, a search procedure between IAB nodes may be considered. Half-duplex constraints and multi-hop topologies including SSB configuration conflict prevention between the IAB nodes as well as IAB node discovery based on a CSI-RS are applied to the search procedure. Specifically, considering a cell ID used by the IAB node, the following two scenarios may be considered.
Case 1: The IAB donor and the IAB node share the same cell ID.
Case 2: The IAB donor and the IAB node use different cell IDs.

In addition, a mechanism for multiplexing random access channel (RACH) transmission from the UE and RACH transmission from the IAB node needs to be further considered.

In the case of SA, the initial IAB node discovery by the MT follows the same initial access procedure of the UE in Rel-15. The initial access procedure may include cell search, system information (SI) acquisition, and random access based on the same SSB used for access UEs in order to establish a connection with an upper IAB node or the IAB donor.

In the case of NSA deployment, when the IAB node MT performs initial access through an NR carrier (from the perspective of the access UE), the same initial access procedure as in SA deployment may be performed. In this case, the SSB/RMSI (remaining minimum system information) periodicity assumed by the MT for initial access may be longer than 20 ms, which is assumed by the Rel-15 UE. For example, one of the candidate values of 20 ms, 40 ms, 80 ms, or 160 ms may be selected.

However, in such cases, a candidate parent IAB node/donor needs to support both NSA functionality for the UE and SA functionality for the MT performing initial access through the NR carrier.

### Scheduling Method for Backhaul and Access Links

Downlink IAB node transmission (i.e., backhaul link transmission from the IAB node to a child IAB node provided by the IAB node and access link transmission from the IAB node to a UE receiving services from the IAB node) may be scheduled by the IAB node.

On the other hand, uplink IAB transmission (i.e., backhaul link transmission from the IAB node to a parent IAB node or IAB donor) may be scheduled by the parent IAB node or IAB donor.

Hereinafter, an RRC connection method for a mobile IAB node according to embodiments of the present disclosure will be described.

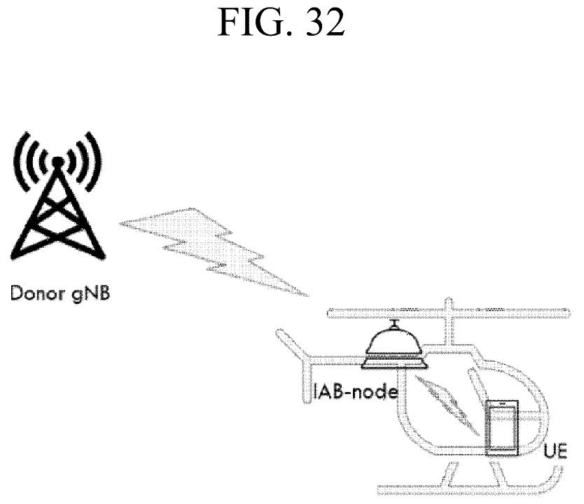

FIG. 32 illustrates a scenario where the embodiments of the present disclosure are applied.

Referring to FIG. 32, the embodiments of the present disclosure illustrate the provision of mobile communication services by equipping a mobile IAB node on an aerial vehicle such as a flying taxi in a network that provides UAM services.

In other words, an IAB node is mounted on an aerial vehicle to implement a mobile IAB node, UAM services are provided to a UE mounted on the aerial vehicle through the IAB node.

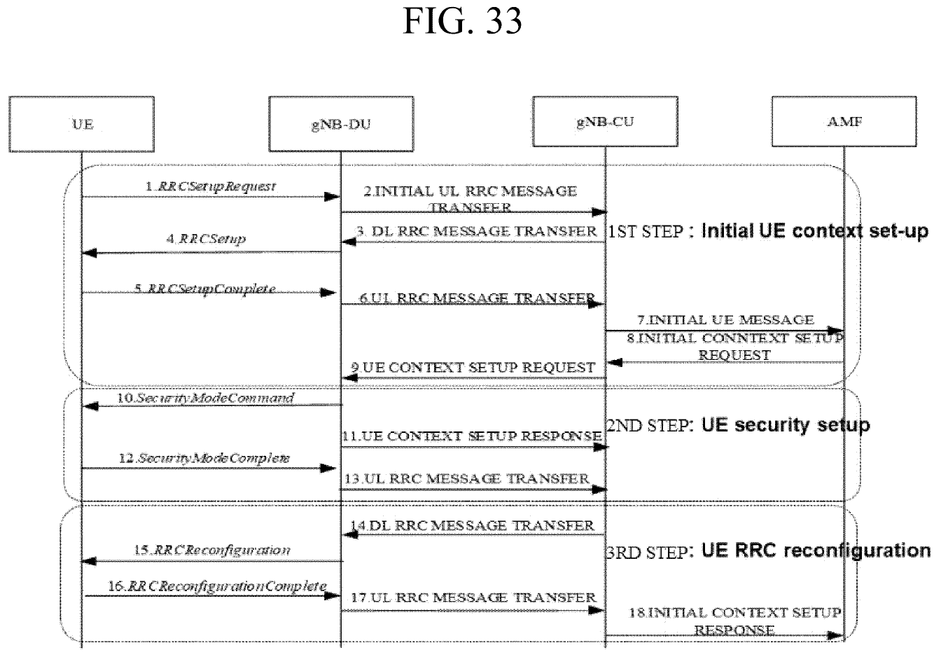

FIG. 33 is a diagram for explaining an initial access procedure method for a normal UE in a 5G system.

Referring to FIG. 33, the initial access procedure for the normal UE in the 5G system may be broadly divided into three steps: [Initial UE context setup], [UE security setup], and [UE RRC reconfiguration].

In the initial UE context setup step, basic UE ID information is transmitted from the UE to a gNB-DU via an RRCSetupRequest message. Upon receiving the information from the gNB-DU, a gNB-CU may then assign an appropriate cell radio network temporary identifier (C-RNTI) value to the UE. The gNB-CU may obtain UE context information from an AMF and forward the UE context information to the gNB-DU. The UE context information may include encryption mode information for appropriate encapsulation.

In the UE security setup step, encryption between the UE and gNB may be performed based on the encryption mode information obtained during the initial UE context setup step.

In the UE RRC reconfiguration step, an RRC reconfiguration message may be encrypted based on the encryption performed during the UE security setup step, and a reconfiguration related to UE RRC may then be carried out.

As shown in FIG. 28, the IAB node is composed of an IAB-DU and an IAB-MT.

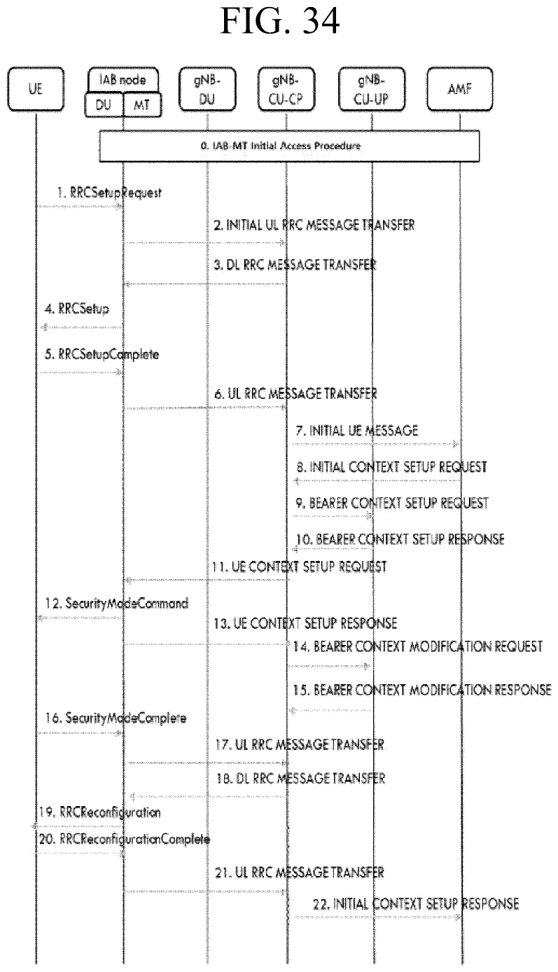

Referring to FIG. 34, an RRC connection between the IAB-MT and a donor gNB-DU/CU (0. IAB-MT Initial Access Procedure) may be carried out as described in FIG. 33. For example, the IAB-MT may correspond to the UE in FIG. 33. The IAB-MT may operate in the same manner as the UE in FIG. 33 and exchange messages corresponding to those in FIG. 33 with the gNB-DU/CU to perform the RRC connection with the gNB-DU/CU.

In addition, the UE may establish the RRC connection (1. RRCSetupRequest to 5. RRCSetupComplete) by following the procedure described in FIG. 33 between the IAB-DU and the gNB-CU.

In this case, the UE context information and mapping information between the IAB node and the UE may be obtained through “2. Initial UL RRC Message Transfer” in FIG. 34.

According to the present disclosure, when a UAM ascends above a specific altitude after the UE is mounted on the UAM (i.e., UAM equipped with the IAB node), the IAB node may transmit related information to the donor gNB-DU through measurement information. In this case, the donor gNB-CU may transmit a new RRC reconfiguration message to other UEs connected to the LAB node to prevent frequent handovers while in the air.

After the UE enters an idle mode and searches for a new cell, the UE may transmit a message for configuring a priority to search for the IAB-DU over other cells.

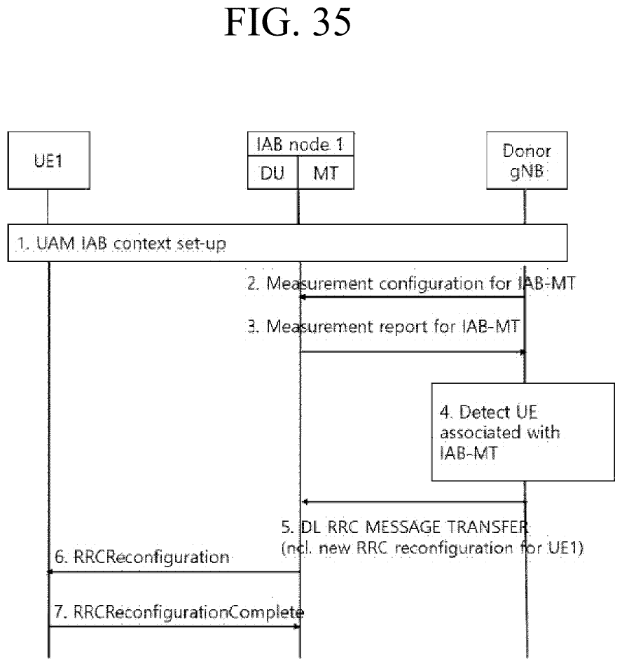

Details of the embodiments of the present disclosure will be described with reference to FIG. 35.

### 1. UAM IAB Context Setup

Referring to FIG. 35, during an initial setup, IAB node 1 may notify a UE and/or a donor gNB that IAB node 1 is a UAM IAB node. Accordingly, the donor gNB may recognize that donor gNB needs to separately instruct IAB node 1 to provide a measurement report depending on the altitude. The donor gNB may also recognize that the donor gNB needs to transmit a separate RRC reconfiguration message to UEs connected to IAB node 1 depending on the situation.

In addition, during this step, the donor gNB may obtain information on the UEs associated with IAB node 1. For example, IAB node 1 may provide the donor gNB with information for identifying the UEs connected to IAB node 1 along with an indicator for notifying that IAB node 1 is the UAM IAB node.

For example, IAB node 1 may provide the donor gNB with information on a plurality of UEs including UE 1. In this case, the plurality of UEs including UE 1 are UEs connected to the donor gNB.

### 2. Measurement Configuration for IAB-MT

When IAB node 1 takes off and reaches a specific altitude, the donor gNB may transmit an IAB-MT configuration to IAB node 1 to instruct IAB node 1 to measure the altitude and channel strength thereof and report the altitude and channel strength to the donor gNB.

For example, the donor gNB may transmit the IAB-MT configuration to IAB node 1, which includes at least one altitude and at least one threshold. For instance, the thresholds may be H1 (e.g., 150 m), H2 (e.g., 300 m), and H3 (e.g., 450 m).

### 3. Measurement Report for IAB-MT

When the IAB-MT of IAB node 1 reaches the specific altitude, IAB node 1 may report measurement information to the donor gNB. For example, the measurement information may include at least one of the following three values.
Absolute Altitude: The absolute altitude refers to the height at which the IAB-MT of IAB node 1 is located, which may be an absolute value, such as 100 m, 200 m, etc.
Threshold: For example, when the at least one threshold is set to H1 (e.g., 150 m), H2 (e.g., 300 m), and H3 (e.g., 450 m) as described above, IAB node 1 may report one of these values (H1, H2, or H3) to the donor gNB.

In this case, the reported value indicates that the IAB-MT of IAB node 1 is located at an altitude that exceeds a certain threshold but is less than another threshold (e.g., a higher threshold). For example, if IAB node 1 reports H2 to the donor gNB, it may mean that IAB node 1 is flying at an altitude between 300 m and 450 m.
Channel Strength: The channel strength refers to a measurement value measured by IAB node 1, which may include at least one of the following: reference signal received power (RSRP), reference signal received quality (RSRQ), or signal-to-noise ratio (SINR).
   4. Detect UE Associated with IAB-MT

The donor gNB may determine that IAB node 1 is flying at the specific altitude based on “3. Measurement Report for IAB-MT” described above. The donor gNB may identify UEs targeted for a new RRC reconfiguration based on the information on the UEs associated with IAB node 1, which was obtained through “1. UAM IAB Context Setup.” In other words, the donor gNB may generate the new RRC reconfiguration for each targeted UE.

### 5. DL RRC Message Transfer

The donor gNB may create a new RRC reconfiguration for the UEs targeted for the reconfiguration, which were identified through “4. Detect UE Associated with IAB-MT,” and send the new RRC reconfiguration to an IAB-DU. For example, the donor gNB may transmit the new RRC reconfiguration to the IAB-MT, and the IAB-MT may then forward the new RRC reconfiguration to the IAB-DU.

### 6. RRC Reconfiguration

The IAB-DU of IAB node 1 may transmit a new RRC reconfiguration message to UE 1, which was identified through “5. DL RRC Message Transfer.” In this case, the RRC reconfiguration message may include at least one of the following examples.
TTT Information: The TTT information is a value that ensures a measurement report for a handover is only performed for a neighboring cell only if the duration for which the measurement strength in the neighboring cell remains above a specific threshold is sufficiently longer than that of the serving cell (e.g., exceeds a specific duration). For example, if the duration for which the measurement strength in the neighboring cell exceeds the specific threshold is equal to or greater than the TTT value, a handover to the neighboring cell may be performed.

Therefore, as the TTT increase, the duration for which the measurement strength in the neighboring cell needs to remain above the specific threshold also needs to increase in response to the TTT to perform the handover. Particularly when IAB node 1 and/or UE 1 are airborne as in the embodiments described in the present disclosure, the TTT may need to be sufficiently longer.

In addition, when a plurality of thresholds (e.g., H1, H2, and H3) are configured, different TTT values may be configured for each of the thresholds. For example, a first TTT may be configured based on the H1 threshold, a second TTT, which is different from the first TTT, may be configured based on the H2 threshold, and a third TTT, which is different from both the first and second TTTs, may be configured based on to the H3 threshold.
Cell Reselection Information: Cell reselection corresponds to information that assists the UE in searching for a suitable cell when the UE reestablishes an RRC connection after experiencing a radio link failure (RLF) or transitioning to the idle mode.

In the present disclosure, information for configuring a priority may be transmitted to UE 1 through an RRC reconfiguration message, thereby allowing the UE to finding the IAB node first rather than a terrestrial BS. The cell reselection information may include at least one of the following examples.
Cell ID Information of IAB-DU: The cell ID information of the IAB-DU may include information on the physical ID of the IAB-DU. Based on the information, UE 1 may attempt to connect to the IAB-DU corresponding to the physical ID with the highest priority during the cell reselection.
Cell Reselection Fail Time: The cell reselection fail time is to prevent UE 1 from reselecting another cell until the cell reselection fail time passes after the connection to the IAB-DU corresponding to the previously connected cell ID is disconnected.

### 7. RRC Reconfiguration Complete

By receiving RRC reconfiguration information and transmitting an RRC reconfiguration complete message to the IAB-DU of IAB node 1, UE 1 may indicate that UE 1 accepts the RRC reconfiguration.

Referring to FIG. 10, if the first device 100 is IAB node 1, the processor(s) 102 may perform “1. UAM IAB Context Setup” with the donor gNB and control the transceiver(s) 106 to receive the IAB-MT configuration from the donor gNB based on “2. Measurement Configuration for IAB-MT” as described in FIG. 35.

The processor(s) (102) may control the transceiver(s) 106 to transmit the measurement information to the donor gNB based on “3. Measurement Report for IAB-MT.”

The processor(s) (102) may control the transceiver(s) 106 to receive the RRC reconfiguration from the donor gNB based on “5. DL RRC Message Transfer” and then control the transceiver(s) 106 to transmit the RRC reconfiguration message to UE 1 based on “6. RRC Reconfiguration.”

The processor(s) (102) may control the transceiver(s) 106 to receive the RRC reconfiguration complete message from UE 1 based on “7. RRC Reconfiguration Complete.”

For example, if the second wireless device 200 is the donor gNB, the processor(s) 202 may perform “1. UAM IAB Context Setup” with IAB node 1 and control the transceiver(s) 206 to transmit the IAB-MT configuration to IAB node 1 based on “2. Measurement Configuration for IAB-MT” as described in FIG. 35.

The processor(s) 202 may control the transceiver(s) 206 to receive the measurement information from IAB node 1 based on “3. Measurement Report for IAB-MT.”

The processor(s) 202 may determine UEs targeted for the RRC reconfiguration based on “4. Detect UE Associated with IAB-MT.” The processor(s) 202 may also control the transceiver(s) 206 to transmit the RRC reconfiguration to IAB node 1 based on “5. DL RRC Message Transfer.”

The embodiments described above may be implemented using hardware components, software components, and/or a combination of hardware and software components. For example, the devices, methods, and components described in the embodiments may be implemented using one or more general-purpose or special-purpose computers, such as a processor, a controller, an arithmetic logic unit (ALU), a digital signal processor (DSP), a microcomputer, a field programmable gate array (FPGA), a programmable logic unit (PLU), a microprocessor, or any other device capable of executing and responding to instructions. A processing device may execute an operating system (OS) and one or more software applications running on the OS. The processing device may access, store, manipulate, process, and generate data in response to the execution of software. For ease of understanding, the processing device may have been described as a single unit, but it may be understood by those skilled in the art that the processing device may include multiple processing elements and/or multiple types of processing elements. For example, the processing device may include multiple processors or a combination of a processor and a controller. Other processing configurations such as a parallel processor are also allowed.

Software may include a computer program, code, instructions, or any combination thereof and may configure the processing device to operate as desired or collectively command the processing device independently or in combination. Software and/or data may be embodied, either permanently or temporarily, in any type of machine, component, physical device, virtual equipment, computer storage medium or device, or transmitted signal wave, in order to be interpreted by the processing device or provide instructions or data to the processing device. Software may also be distributed across networked computer systems, stored, or executed in a distributed manner. Software and data may be stored on one or more computer-readable recording media.

The method according to the embodiment may be implemented in the form of program instructions that may be executed through various computer means and recorded on a computer-readable medium. The computer-readable medium may include program instructions, data files, data structures, or a combination thereof. The program instructions recorded on the medium may be specifically designed and configured for the embodiment or may be known and available to those skilled in computer software. Examples of computer-readable recording media include magnetic media such as hard disks, floppy disks, and magnetic tapes; optical media such as compact disc read-only memory (CD-ROM) and digital video disc (DVD); magneto-optical media such as floptical disks; and hardware devices specifically configured to store and execute program instructions such as read-only memory (ROM), random access memory (RAM), and flash memory. Examples of program instructions include not only machine code generated by a compiler but also high-level language code that may be executed by a computer using an interpreter.

As described above, although the embodiments have been explained with reference to specific diagrams, those skilled in the art may apply various technical modifications and variations based on the explanation. For example, the techniques described herein may be performed in a different order than the described methods, and/or the described components such as systems, structures, devices, circuits, etc., may be combined or arranged differently than described, or replaced or substituted with other components or equivalents, while still achieving appropriate results. Therefore, other implementations, embodiments, and equivalents to the appended claims may also be included within the scope of the appended claims.

In this document, the embodiments of the present disclosure have been primarily described with a focus on a signaling relationship between a UE and a BS. The signaling relationship may be similarly extended to signaling between the UE and a relay or between the BS and a relay. In some cases, specific operations described as being performed by the BS in this document may be performed by an upper node. In other words, it is evident that various operations performed for communication with the UE in a network composed of multiple network nodes, including the BS, may be carried out by the BS or by other network nodes other than the BS. The term BS may be replaced by terms such as fixed station, Node B, eNode B (eNB), or access point. Similarly, the term UE may be replaced by terms such as user equipment, mobile station (MS), mobile subscriber station (MSS).

The embodiments according to the present disclosure may be implemented using various means such as hardware, firmware, software, or a combination thereof. In the case of a hardware implementation, an embodiment of the present disclosure may be implemented using one or more ASICs, DSPs, DSPDs, PLDs, FPGAs, processors, controllers, microcontrollers, microprocessors, and so on.

In the case of an implementation using firmware or software, an embodiment of the present disclosure may be implemented in the form of modules, procedures, or functions that perform the functions or operations described above. The software code may be stored in a memory unit and executed by a processor. The memory unit may be located inside or outside the processor and may exchange data with the processor through various means already known.

It will be apparent to those skilled in the art that the present disclosure may be embodied in other specific forms without departing from the features of the present disclosure. Therefore, the above detailed description should not be construed as limiting in any way but rather as illustrative. The scope of the present disclosure should be determined by the reasonable interpretation of the appended claims, and all modifications within the equivalent scope of the present specification are included within the scope of the present disclosure.

In some implementations of the present disclosure, the focus is on a method for performing an ANR between a UE and multiple cells to support UAM services and device therefor. More specifically, the present disclosure relates to a method and device for forming an ANR table by distinguishing between non-terrestrial and terrestrial networks.

According to some implementations of the present disclosure, when using the ANR function in a network providing UAM services, confusion in forming the ANR table may be prevented by adding an identifier that distinguishes between detection reports from terrestrial UEs and non-terrestrial UEs.

According to some implementations of the present disclosure, the final ANR table may have separate tables for the terrestrial network and the non-terrestrial network. Alternatively, the final ANR table may maintain the terrestrial network table as it is by excluding detection reports from non-terrestrial UEs.

According to some implementations of the present disclosure, when a UE is mounted on a UAM device, the UE may efficiently be identified as a UE related to a UAM service by forming slice information on the UAM service and transmitting the slice information to a network.

According to some implementations of the present disclosure, the method for performing the ANR between a UE and multiple cells and device therefor may contribute to the development of the entire communications industry.

1. A method of transmitting a measurement report by a user equipment (UE) in a wireless communication system, comprising:
receiving a transmission request for a first measurement report related to a second cell on a first cell; and
transmitting the first measurement report on the first cell based on the transmission request,
wherein the first measurement report includes aerial operation information on the UE.

2. The method of claim 1, wherein transmitting the first measurement report comprises:
receiving a global cell identification (ID) of the second cell on the second cell; and
transmitting the first measurement report including the global cell ID of the second cell on the first cell.

3. The method of claim 2, wherein the global cell ID of the second cell is received in a broadcasting message of the second cell.

4. The method of claim 1, further comprising transmitting a second measurement report including signal strength information related to the second cell on the first cell.

5. The method of claim 4, wherein based on that information corresponding to the second cell is not present in a neighbor cell relation table (NCRT) of the first cell, the transmission request for the first measurement report is received.

6. The method of claim 1, wherein the aerial operation information includes at least one of altitude information on an altitude at which the UE is located, signal strength measurement information on a signal strength of the second cell, or signal strength duration information on a duration of the signal strength.

7. The method of claim 6, wherein the altitude information is absolute altitude information representing the altitude at which the UE is located as an absolute value.

8. The method of claim 6, wherein the altitude information is altitude level information indicating an altitude level including the altitude at which the UE is located among a plurality of altitude levels.

9. The method of claim 6, wherein based on the aerial operation information, the altitude information is mapped to the second cell within a neighbor cell relation table (NCRT) of the first cell.

10. The method of claim 9, wherein based on that a value of the signal strength measurement information exceeds a first threshold, the altitude information is mapped to the second cell within the NCRT.

11. The method of claim 9, wherein based on a value of the signal strength duration information exceeds a second threshold, the altitude information is mapped to the second cell within the NCRT.

12. The method of claim 1, wherein based on the aerial operation information, a possibility of a handover to the second cell is updated within a neighbor cell relation table (NCRT) of the first cell.

13. The method of claim 1, wherein based on the aerial operation information, a necessity of an Xn interface for the second cell is updated within a neighbor cell relation table (NCRT) of the first cell.

14. The method of claim 1, wherein based on that the UE is mounted on an urban aerial mobility (UAM) device, the UE:
performs authentication for a UAM service with a UAM UE included in the UAM device;
generates slice information related to the UAM service based on the authentication; and
transmits a first message including the slice information to a base station.

15. A user equipment (UE) configured to transmit a measurement report in a wireless communication system, the UE comprising:
at least one transceiver;
at least one processor; and
at least one memory operatively connected to the at least one processor and storing instructions that, when executed, cause the at least one processor to perform operations:
receiving a transmission request for a first measurement report related to a second cell on a first cell through the at least one transceiver; and
transmitting the first measurement report on the first cell based on the transmission request through the at least one transceiver,
wherein the first measurement report includes aerial operation information on the UE.

16. The UE of claim 15, wherein transmitting the first measurement report comprises:
receiving a global cell identification (ID) of the second cell on the second cell; and
transmitting the first measurement report including the global cell ID of the second cell on the first cell.

17. The UE of claim 16, wherein the global cell ID of the second cell is received in a broadcasting message of the second cell.

18. The UE of claim 15, wherein the operations further comprise transmitting a second measurement report including signal strength information related to the second cell on the first cell.

19. The UE of claim 18, wherein based on that information corresponding to the second cell is not present in a neighbor cell relation table (NCRT) of the first cell, the transmission request for the first measurement report is received.

20. The UE of claim 15, wherein the aerial operation information includes at least one of altitude information on an altitude at which the UE is located, signal strength measurement information on a signal strength of the second cell, or signal strength duration information on a duration of the signal strength.

21. The UE of claim 20, wherein the altitude information is absolute altitude information representing the altitude at which the UE is located as an absolute value.

22. The UE of claim 20, wherein the altitude information is altitude level information indicating an altitude level including the altitude at which the UE is located among a plurality of altitude levels.

23. The UE of claim 20, wherein based on the aerial operation information, the altitude information is mapped to the second cell within a neighbor cell relation table (NCRT) of the first cell.

24. The UE of claim 23, wherein based on that a value of the signal strength measurement information exceeds a first threshold, the altitude information is mapped to the second cell within the NCRT.

25. The UE of claim 23, wherein based on a value of the signal strength duration information exceeds a second threshold, the altitude information is mapped to the second cell within the NCRT.

26. The UE of claim 15, wherein based on the aerial operation information, a possibility of a handover to the second cell is updated within a neighbor cell relation table (NCRT) of the first cell.

27. The UE of claim 15, wherein based on the aerial operation information, a necessity of an Xn interface for the second cell is updated within a neighbor cell relation table (NCRT) of the first cell.

28. A method of receiving a measurement report by a device in a wireless communication system, the method comprising:
transmitting a transmission request for a first measurement report related to a second cell to a user equipment (UE) on a first cell; and
receiving the first measurement report from the UE on the first cell based on the transmission request,
wherein the first measurement report includes aerial operation information on the UE.

29. A device configured to receive a measurement report from a user equipment (UE) in a wireless communication system, the device comprising:
at least one transceiver;
at least one processor; and
at least one memory operatively connected to the at least one processor and storing instructions that, when executed, cause the at least one processor to perform operations:
transmitting a transmission request for a first measurement report related to a second cell to the UE on a first cell; and
receiving the first measurement report from the UE on the first cell based on the transmission request,
wherein the first measurement report includes aerial operation information on the UE.
